(19) United States
(12) Patent Application Publication
(10) Pub. No.: US 2026/0332308 A1
(43) Pub. Date: Oct. 22, 2026

(54) INDICATION OF HARQ FEEDBACK ENABLEMENT OR DISABLEMENT

(71) Applicant: Parsa Wireless Communications LLC, Stamford, CT (US)

(72) Inventor: Alireza Babaei, Fairfax, VA (US)

(73) Assignee: Parsa Wireless Communications LLC, Stamford, CT (US)

(21) Appl. No.: 19/016,292

(22) PCT Filed: Jul. 10, 2023
(86) PCT No.: PCT/US2023/027206

§ 371 Date: Jan. 10, 2025

Related U.S. Application Data
(60) Provisional application No. 63/359,910, filed on Jul. 11, 2022.

(51) Int. Cl. H04L 1/1812; H04W 72/11; H04W 72/23

(52) U.S. Cl. CPC H04L 1/1812; H04W 72/11; H04W 72/23

(57) ABSTRACT

A method of disabling hybrid automatic repeat request (HARQ) feedback in a non-terrestrial network includes steps of receiving, by a user equipment (UE), one of a radio resource control (RRC) message, a medium access control (MAC) control element (CE) and a downlink control information (DCI) and determining to transmit or not to transmit the HARQ feedback for the first HARQ process based on the second value. In the method, the RRC message, the MAC CE and the DCI comprise a first field and a second field; a first value of the first field indicates a first serving cell; and a second value of the second field indicates whether HARQ feedback is enabled or disabled for a first HARQ process of the first serving cell.

### CROSS-REFERENCE TO RELATED APPLICATIONS

This application claims priority under 35 USC § 119(e) from U.S. Provisional Patent Application No. 63/359,910, filed on Jul. 11, 2022 (“the provisional application”); the content of the provisional patent application is incorporated herein by reference.

### BACKGROUND OF THE INVENTION

The present invention is directed to 5G, which is the 5^{th} generation mobile network. It is a new global wireless standard after 1G, 2G, 3G, and 4G networks. 5G enables networks designed to connect machines, objects and devices.

The invention is more specifically directed to systems and/or methods for enhancing existing signaling and processes to enable HARQ feedback enablement/disablement and corresponding processes. Example embodiments enhance the existing signaling and processes to enable HARQ feedback enablement/disablement and corresponding processes.

### SUMMARY OF THE INVENTION

In an embodiment, the invention provides a method of disabling hybrid automatic repeat request (HARQ) feedback in a non-terrestrial network includes steps of receiving, by a user equipment (UE), one of a radio resource control (RRC) message, a medium access control (MAC) control element (CE) and a downlink control information (DCI) and determining to transmit or not to transmit the HARQ feedback for the first HARQ process based on a value of a field of the RRC message or the DCI or the MAC CE. In the method, the RRC message, the MAC CE and the DCI comprise a first field and a second field; a first value of the first field indicates a first serving cell; and a second value of the second field indicates whether HARQ feedback is enabled or disabled for a first HARQ process of the first serving cell.

The second field comprises a plurality of bits, where each bit in the plurality of bits corresponds to a hybrid automatic repeat request (HARQ) process and a value of a first bit in the plurality of bits indicates whether HARQ feedback is enabled or disabled for the first HARQ process of the first serving cell. The first value of the first field can indicate that the second field is associated with the first serving cell. The first value of the first field can indicate a first identifier of the first serving cell. The first field may comprise a first field plurality of bits and a value of a first bit in the first field plurality of bits can indicate the first serving cell. The first bit preferably corresponds to the first serving cell. In an embodiment, the first bit is one.

In the method, the medium access control (MAC) control element (CE) can be associated with a first logical channel identifier (LCID) and the first LCID can be for indication of enabling or disabling one or more hybrid automatic repeat request (HARQ) processes. The downlink control information (DCI) may be associated with a radio network temporary identifier (RNTI). The radio network temporary identifier (RNTI) may indicate enabling or disabling one or more hybrid automatic repeat request (HARQ) processes. The downlink control information (DCI) can be a downlink or uplink scheduling DCI. The scheduling downlink control information (DCI) may comprise scheduling information for reception of a transport block; and the scheduling DCI may indicate whether the hybrid automatic repeat request (HARQ) feedback associated with the transport block is enabled or disabled.

The method may further comprise receiving configuration parameters of a semi-persistent scheduling (SPS) configuration, wherein the downlink control information (DCI) is an activation DCI. The activation downlink control information (DCI) may indicate whether hybrid automatic repeat request (HARQ) feedback is enabled or disabled for transport blocks associated with the semi-persistent scheduling (SPS) configuration. The transport blocks associated with the semi-persistent scheduling (SPS) configuration can be associated with different hybrid automatic repeat request (HARQ) processes; and the HARQ feedback may be enabled or disabled for the transport blocks regardless of the HARQ processes associated with the transport blocks. The method may further comprise generating a hybrid automatic repeat request (HARQ) feedback codebook for transmission via an uplink control channel. The hybrid automatic repeat request (HARQ) feedback codebook may comprise HARQ feedback for one or more HARQ processes for which HARQ feedback is enabled.

A size of the hybrid automatic repeat request (HARQ) feedback codebook may be based on a number of HARQ processes for which HARQ feedback is enabled. The method may comprise flushing a hybrid automatic repeat request (HARQ) buffer associated with a HARQ process for which the HARQ feedback is disabled in response to receiving an indication to disable the HARQ feedback for the HARQ process. The method may comprise receiving a retransmission grant for a hybrid automatic repeat request (HARQ) process for which the HARQ feedback is disabled; and ignoring the retransmission grant. The method may comprise receiving a retransmission grant for a hybrid automatic repeat request (HARQ) process for which the HARQ feedback is disabled; and enabling HARQ feedback for the HARQ process in response to receiving the retransmission grant.

The method may further include transmitting a hybrid automatic repeat request (HARQ) feedback associated with a transport block received based on the retransmission grant. The hybrid automatic repeat request (HARQ) feedback associated with the HARQ process for which HARQ feedback is disabled can be a positive acknowledgement. A hybrid automatic repeat request (HARQ) feedback for a HARQ process may be disabled based on a size of a scheduled transport block associated with the HARQ process. The method may comprise receiving a scheduling downlink control information (DCI) or a semi-persistent scheduling (SPS) activation DCI, wherein the scheduling DCI or the SPS activation DCI indicates the size of the scheduled transport block.

The size of the scheduled transport block may be based on a modulation and coding scheme and resources allocated for reception of the transport. The scheduling downlink control information (DCI) or the semi-persistent scheduling (SPS) activation DCI may indicate the modulation and coding scheme and the resources. The indication of the second value of the second field may further indicate the duration that a hybrid automatic repeat request (HARQ) feedback is disabled. The duration may be indicated by a number of slots. The duration may be indicated by a number of subframes. The duration may be indicated by a number of frames. A format associated with the medium access control (MAC) control element (CE) may indicate that the MAC is for enabling or disabling hybrid automatic repeat request (HARQ) feedback for one or more HARQ processes. A format associated with the downlink control information (DCI) may indicate that the DCI is for enabling or disabling hybrid automatic repeat request (HARQ) feedback for one or more HARQ processes.

### BRIEF DESCRIPTION OF THE DRAWINGS

FIG. 1 shows an example of a system of mobile communications according to some aspects of some of various exemplary embodiments of the present disclosure.

FIG. 2A and FIG. 2B show examples of radio protocol stacks for user plane and control plane, respectively, according to some aspects of some of various exemplary embodiments of the present disclosure.

FIG. 3A, FIG. 3B and FIG. 3C show example mappings between logical channels and transport channels in downlink, uplink and sidelink, respectively, according to some aspects of some of various exemplary embodiments of the present disclosure.

FIG. 4A, FIG. 4B and FIG. 4C show example mappings between transport channels and physical channels in downlink, uplink and sidelink, respectively, according to some aspects of some of various exemplary embodiments of the present disclosure.

FIG. 5A, FIG. 5B, FIG. 5C and FIG. 5D show examples of radio protocol stacks for NR sidelink communication according to some aspects of some of various exemplary embodiments of the present disclosure.

FIG. 6 shows example physical signals in downlink, uplink and sidelink according to some aspects of some of various exemplary embodiments of the present disclosure.

FIG. 7 shows examples of Radio Resource Control (RRC) states and transitioning between different RRC states according to some aspects of some of various exemplary embodiments of the present disclosure.

FIG. 8 shows example frame structure and physical resources according to some aspects of some of various exemplary embodiments of the present disclosure.

FIG. 9 shows example component carrier configurations in different carrier aggregation scenarios according to some aspects of some of various exemplary embodiments of the present disclosure.

FIG. 10 shows example bandwidth part configuration and switching according to some aspects of some of various exemplary embodiments of the present disclosure.

FIG. 11 shows example four-step contention-based and contention-free random access processes according to some aspects of some of various exemplary embodiments of the present disclosure.

FIG. 12 shows example two-step contention-based and contention-free random access processes according to some aspects of some of various exemplary embodiments of the present disclosure.

FIG. 13 shows example time and frequency structure of Synchronization Signal and Physical Broadcast Channel (PBCH) Block (SSB) according to some aspects of some of various exemplary embodiments of the present disclosure.

FIG. 14 shows example SSB burst transmissions according to some aspects of some of various exemplary embodiments of the present disclosure.

FIG. 15 shows example components of a user equipment and a base station for transmission and/or reception according to some aspects of some of various exemplary embodiments of the present disclosure.

FIG. 16 shows an example process according to some aspects of some of various exemplary embodiments of the present disclosure.

FIG. 17 shows an example field of a command/indication according to some aspects of some of various exemplary embodiments of the present disclosure.

FIG. 18 shows an example field of a command/indication according to some aspects of some of various exemplary embodiments of the present disclosure.

FIG. 19 shows an example process according to some aspects of some of various exemplary embodiments of the present disclosure.

FIG. 20 is an example process according to some aspects of some of various exemplary embodiments of the present disclosure.

### DETAILED DESCRIPTION

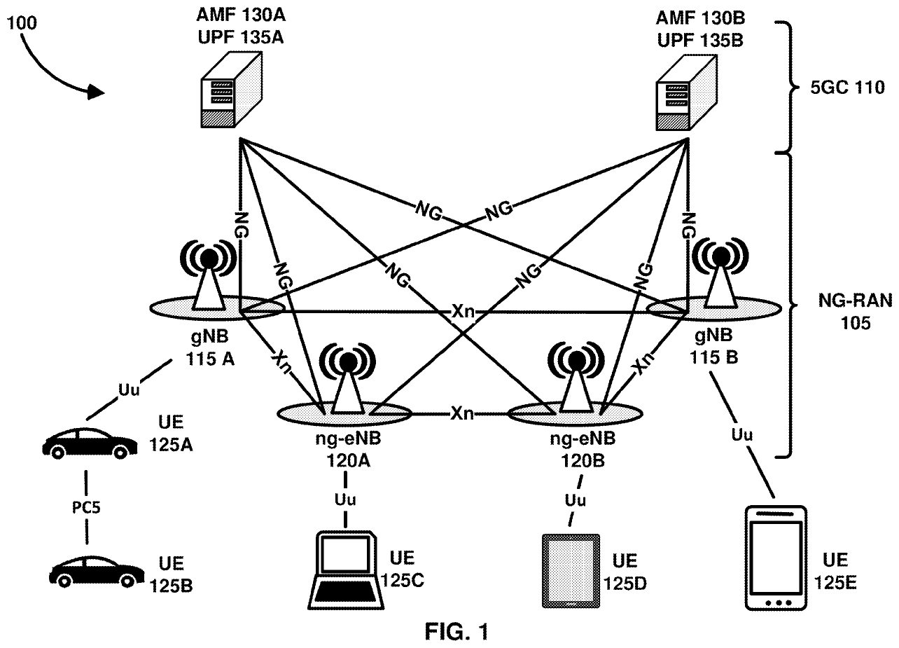

FIG. 1 shows an example of a system of mobile communications 100 according to some aspects of some of various exemplary embodiments of the present disclosure. The system of mobile communication 100 may be operated by a wireless communications system operator such as a Mobile Network Operator (MNO), a private network operator, a Multiple System Operator (MSO), an Internet of Things (IOT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial IOT (IIOT), etc.

The system of mobile communications 100 may enable various types of applications with different requirements in terms of latency, reliability, throughput, etc. Example supported applications include enhanced Mobile Broadband (eMBB), Ultra-Reliable Low-Latency Communications (URLLC), and massive Machine Type Communications (mMTC). eMBB may support stable connections with high peak data rates, as well as moderate rates for cell-edge users. URLLC may support applications with strict requirements in terms of latency and reliability and moderate requirements in terms of data rate. Example mMTC application includes a network of a massive number of IoT devices, which are only sporadically active and send small data payloads.

The system of mobile communications 100 may include a Radio Access Network (RAN) portion and a core network portion. The example shown in FIG. 1 illustrates a Next Generation RAN (NG-RAN) 105 and a 5G Core Network (5GC) 110 as examples of the RAN and core network, respectively. Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), etc. Other examples of core network include Evolved Packet Core (EPC), UMTS Core Network (UCN), etc. The RAN implements a Radio Access Technology (RAT) and resides between User Equipments (UEs) 125 and the core network. Examples of such RATs include New Radio (NR), Long Term Evolution (LTE) also known as Evolved Universal Terrestrial Radio Access (EUTRA), Universal Mobile Telecommunication System (UMTS), etc. The RAT of the example system of mobile communications 100 may be NR. The core network resides between the RAN and one or more external networks (e.g., data networks) and is responsible for functions such as mobility management, authentication, session management, setting up bearers and application of different Quality of Services (QoSs). The functional layer between the UE 125 and the RAN (e.g., the NG-RAN 105) may be referred to as Access Stratum (AS) and the functional layer between the UE 125 and the core network (e.g., the 5GC 110) may be referred to as Non-access Stratum (NAS).

The UEs 125 may include wireless transmission and reception means for communications with one or more nodes in the RAN, one or more relay nodes, or one or more other UEs, etc. Examples of UEs include, but are not limited to, smartphones, tablets, laptops, computers, wireless transmission and/or reception units in a vehicle, V2X or Vehicle to Vehicle (V2V) devices, wireless sensors, IoT devices, IIOT devices, etc. Other names may be used for UEs such as a Mobile Station (MS), terminal equipment, terminal node, client device, mobile device, etc.

The RAN may include nodes (e.g., base stations) for communications with the UEs. For example, the NG-RAN 105 of the system of mobile communications 100 may comprise nodes for communications with the UEs 125. Different names for the RAN nodes may be used, for example depending on the RAT used for the RAN. A RAN node may be referred to as Node B (NB) in a RAN that uses the UMTS RAT. A RAN node may be referred to as an evolved Node B (eNB) in a RAN that uses LTE/EUTRA RAT. For the illustrative example of the system of mobile communications 100 in FIG. 1, the nodes of an NG-RAN 105 may be either a next generation Node B (gNB) 115 or a next generation evolved Node B (ng-eNB) 120. In this specification, the terms base station, RAN node, gNB and ng-eNB may be used interchangeably. The gNB 115 may provide NR user plane and control plane protocol terminations towards the UE 125. The ng-eNB 120 may provide E-UTRA user plane and control plane protocol terminations towards the UE 125. An interface between the gNB 115 and the UE 125 or between the ng-eNB 120 and the UE 125 may be referred to as a Uu interface. The Uu interface may be established with a user plane protocol stack and a control plane protocol stack. For a Uu interface, the direction from the base station (e.g., the gNB 115 or the ng-eNB 120) to the UE 125 may be referred to as downlink and the direction from the UE 125 to the base station (e.g., gNB 115 or ng-eNB 120) may be referred to as uplink.

The gNBs 115 and ng-eNBs 120 may be interconnected with each other by means of an Xn interface. The Xn interface may comprise an Xn User plane (Xn-U) interface and an Xn Control plane (Xn-C) interface. The transport network layer of the Xn-U interface may be built on Internet Protocol (IP) transport and GPRS Tunneling Protocol (GTP) may be used on top of User Datagram Protocol (UDP)/IP to carry the user plane protocol data units (PDUs). Xn-U may provide non-guaranteed delivery of user plane PDUs and may support data forwarding and flow control. The transport network layer of the Xn-C interface may be built on Stream Control Transport Protocol (SCTP) on top of IP. The application layer signaling protocol may be referred to as XnAP (Xn Application Protocol). The SCTP layer may provide the guaranteed delivery of application layer messages. In the transport IP layer, point-to-point transmission may be used to deliver the signaling PDUs. The Xn-C interface may support Xn interface management, UE mobility management, including context transfer and RAN paging, and dual connectivity.

The gNBs 115 and ng-eNBs 120 may also be connected to the 5GC 110 by means of the NG interfaces, more specifically to an Access and Mobility Management Function (AMF) 130 of the 5GC 110 by means of the NG-C interface and to a User Plane Function (UPF) 135 of the 5GC 110 by means of the NG-U interface. The transport network layer of the NG-U interface may be built on IP transport and GTP protocol may be used on top of UDP/IP to carry the user plane PDUs between the NG-RAN node (e.g., gNB 115 or ng-eNB 120) and the UPF 135. NG-U may provide non-guaranteed delivery of user plane PDUs between the NG-RAN node and the UPF. The transport network layer of the NG-C interface may be built on IP transport. For the reliable transport of signaling messages, SCTP may be added on top of IP. The application layer signaling protocol may be referred to as NGAP (NG Application Protocol). The SCTP layer may provide guaranteed delivery of application layer messages. In the transport, IP layer point-to-point transmission may be used to deliver the signaling PDUs. The NG-C interface may provide the following functions: NG interface management; UE context management; UE mobility management; transport of NAS messages; paging; PDU Session Management; configuration transfer; and warning message transmission.

The gNB 115 or the ng-eNB 120 may host one or more of the following functions: Radio Resource Management functions such as Radio Bearer Control, Radio Admission Control, Connection Mobility Control, Dynamic allocation of resources to UEs in both uplink and downlink (e.g., scheduling); IP and Ethernet header compression, encryption and integrity protection of data; Selection of an AMF at UE attachment when no routing to an AMF can be determined from the information provided by the UE; Routing of User Plane data towards UPF(s); Routing of Control Plane information towards AMF; Connection setup and release; Scheduling and transmission of paging messages; Scheduling and transmission of system broadcast information (e.g., originated from the AMF); Measurement and measurement reporting configuration for mobility and scheduling; Transport level packet marking in the uplink; Session Management; Support of Network Slicing; QoS Flow management and mapping to data radio bearers; Support of UEs in RRC Inactive state; Distribution function for NAS messages; Radio access network sharing; Dual Connectivity; Tight interworking between NR and E-UTRA; and Maintaining security and radio configuration for User Plane 5G system (5GS) Cellular IoT (CIoT) Optimization.

The AMF 130 may host one or more of the following functions: NAS signaling termination; NAS signaling security; AS Security control; Inter CN node signaling for mobility between 3GPP access networks; Idle mode UE Reachability (including control and execution of paging retransmission); Registration Area management; Support of intra-system and inter-system mobility; Access Authentication; Access Authorization including check of roaming rights; Mobility management control (subscription and policies); Support of Network Slicing; Session Management Function (SMF) selection; Selection of 5GS CIoT optimizations.

The UPF 135 may host one or more of the following functions: Anchor point for Intra-/Inter-RAT mobility (when applicable); External PDU session point of interconnect to Data Network; Packet routing & forwarding; Packet inspection and User plane part of Policy rule enforcement; Traffic usage reporting; Uplink classifier to support routing traffic flows to a data network; Branching point to support multi-homed PDU session; QoS handling for user plane, e.g. packet filtering, gating, UL/DL rate enforcement; Uplink Traffic verification (Service Data Flow (SDF) to QoS flow mapping); Downlink packet buffering and downlink data notification triggering.

As shown in FIG. 1, the NG-RAN 105 may support the PC5 interface between two UEs 125 (e.g., UE 125A and UE125B). In the PC5 interface, the direction of communications between two UEs (e.g., from UE 125A to UE 125B or vice versa) may be referred to as sidelink. Sidelink transmission and reception over the PC5 interface may be supported when the UE 125 is inside NG-RAN 105 coverage, irrespective of which RRC state the UE is in, and when the UE 125 is outside NG-RAN 105 coverage. Support of V2X services via the PC5 interface may be provided by NR sidelink communication and/or V2X sidelink communication.

PC5-S signaling may be used for unicast link establishment with Direct Communication Request/Accept message. A UE may self-assign its source Layer-2 ID for the PC5 unicast link for example based on the V2X service type. During unicast link establishment procedure, the UE may send its source Layer-2 ID for the PC5 unicast link to the peer UE, e.g., the UE for which a destination ID has been received from the upper layers. A pair of source Layer-2 ID and destination Layer-2 ID may uniquely identify a unicast link. The receiving UE may verify that the said destination ID belongs to it and may accept the Unicast link establishment request from the source UE. During the PC5 unicast link establishment procedure, a PC5-RRC procedure on the Access Stratum may be invoked for the purpose of UE sidelink context establishment as well as for AS layer configurations, capability exchange etc. PC5-RRC signaling may enable exchanging UE capabilities and AS layer configurations such as Sidelink Radio Bearer configurations between pair of UEs for which a PC5 unicast link is established.

NR sidelink communication may support one of three types of transmission modes (e.g., Unicast transmission, Groupcast transmission, and Broadcast transmission) for a pair of a Source Layer-2 ID and a Destination Layer-2 ID in the AS. The Unicast transmission mode may be characterized by: Support of one PC5-RRC connection between peer UEs for the pair; Transmission and reception of control information and user traffic between peer UEs in sidelink; Support of sidelink HARQ feedback; Support of sidelink transmit power control; Support of RLC Acknowledged Mode (AM); and Detection of radio link failure for the PC5-RRC connection. The Groupcast transmission may be characterized by: Transmission and reception of user traffic among UEs belonging to a group in sidelink; and Support of sidelink HARQ feedback. The Broadcast transmission may be characterized by: Transmission and reception of user traffic among UEs in sidelink.

A Source Layer-2 ID, a Destination Layer-2 ID and a PC5 Link Identifier may be used for NR sidelink communication. The Source Layer-2 ID may be a link-layer identity that identifies a device or a group of devices that are recipients of sidelink communication frames. The Destination Layer-2 ID may be a link-layer identity that identifies a device that originates sidelink communication frames. In some examples, the Source Layer-2 ID and the Destination Layer-2 ID may be assigned by a management function in the Core Network. The Source Layer-2 ID may identify the sender of the data in NR sidelink communication. The Source Layer-2 ID may be 24 bits long and may be split in the MAC layer into two bit strings: One bit string may be the LSB part (8 bits) of Source Layer-2 ID and forwarded to physical layer of the sender. This may identify the source of the intended data in sidelink control information and may be used for filtering of packets at the physical layer of the receiver; and the Second bit string may be the MSB part (16 bits) of the Source Layer-2 ID and may be carried within the Medium Access Control (MAC) header. This may be used for filtering packets at the MAC layer of the receiver. The Destination Layer-2 ID may identify the target of the data in NR sidelink communication. For NR sidelink communication, the Destination Layer-2 ID may be 24 bits long and may be split in the MAC layer into two bit strings: One bit string may be the LSB part (16 bits) of Destination Layer-2 ID and forwarded to physical layer of the sender. This may identify the target of the intended data in sidelink control information and may be used for filtering of packets at the physical layer of the receiver; and the Second bit string may be the MSB part (8 bits) of the Destination Layer-2 ID and may be carried within the MAC header. This may be used for filtering packets at the MAC layer of the receiver. The PC5 Link Identifier may uniquely identify the PC5 unicast link in a UE for the lifetime of the PC5 unicast link. The PC5 Link Identifier may be used to indicate the PC5 unicast link whose sidelink Radio Link failure (RLF) declaration was made and PC5-RRC connection was released.

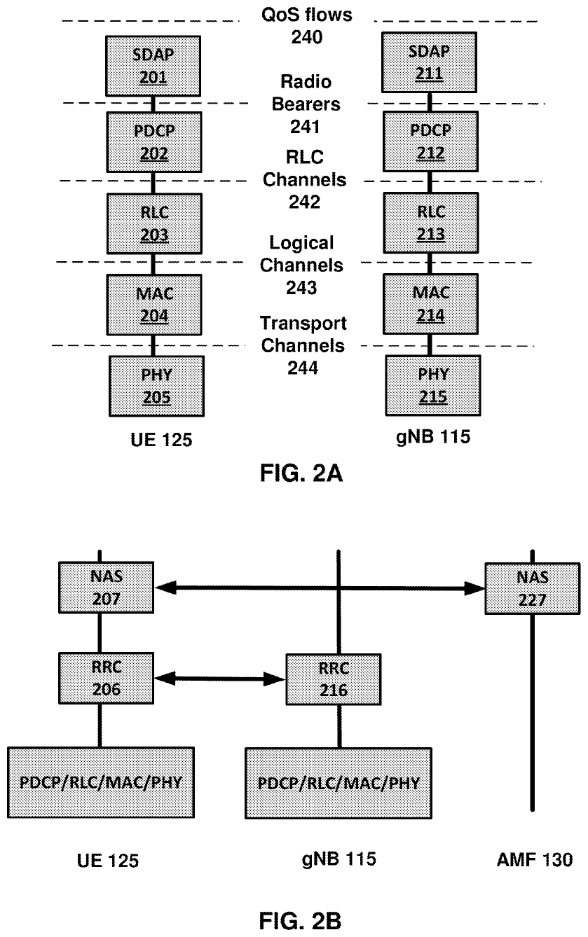

FIG. 2A and FIG. 2B show examples of radio protocol stacks for user plane and control plane, respectively, according to some aspects of some of various exemplary embodiments of the present disclosure. As shown in FIG. 2A, the protocol stack for the user plane of the Uu interface (between the UE 125 and the gNB 115) includes Service Data Adaptation Protocol (SDAP) 201 and SDAP 211, Packet Data Convergence Protocol (PDCP) 202 and PDCP 212, Radio Link Control (RLC) 203 and RLC 213, MAC 204 and MAC 214 sublayers of layer 2 and Physical (PHY) 205 and PHY 215 layer (layer 1 also referred to as L1).

The PHY 205 and PHY 215 offer transport channels 244 to the MAC 204 and MAC 214 sublayer. The MAC 204 and MAC 214 sublayer offer logical channels 243 to the RLC 203 and RLC 213 sublayer. The RLC 203 and RLC 213 sublayer offer RLC channels 242 to the PDCP 202 and PCP 212 sublayer. The PDCP 202 and PDCP 212 sublayer offer radio bearers 241 to the SDAP 201 and SDAP 211 sublayer. Radio bearers may be categorized into two groups: Data Radio Bearers (DRBs) for user plane data and Signaling Radio Bearers (SRBs) for control plane data. The SDAP 201 and SDAP 211 sublayer offers QoS flows 240 to 5GC.

The main services and functions of the MAC 204 or MAC 214 sublayer include: mapping between logical channels and transport channels; Multiplexing/demultiplexing of MAC Service Data Units (SDUs) belonging to one or different logical channels into/from Transport Blocks (TB) delivered to/from the physical layer on transport channels; Scheduling information reporting; Error correction through Hybrid Automatic Repeat Request (HARQ) (one HARQ entity per cell in case of carrier aggregation (CA)); Priority handling between UEs by means of dynamic scheduling; Priority handling between logical channels of one UE by means of Logical Channel Prioritization (LCP); Priority handling between overlapping resources of one UE; and Padding. A single MAC entity may support multiple numerologies, transmission timings and cells. Mapping restrictions in logical channel prioritization control which numerology(ies), cell(s), and transmission timing(s) a logical channel may use.

The HARQ functionality may ensure delivery between peer entities at Layer 1. A single HARQ process may support one TB when the physical layer is not configured for downlink/uplink spatial multiplexing, and when the physical layer is configured for downlink/uplink spatial multiplexing, a single HARQ process may support one or multiple TBs.

The RLC 203 or RLC 213 sublayer may support three transmission modes: Transparent Mode (TM); Unacknowledged Mode (UM); and Acknowledged Mode (AM). The RLC configuration may be per logical channel with no dependency on numerologies and/or transmission durations, and Automatic Repeat Request (ARQ) may operate on any of the numerologies and/or transmission durations the logical channel is configured with.

The main services and functions of the RLC 203 or RLC 213 sublayer depend on the transmission mode (e.g., TM, UM or AM) and may include: Transfer of upper layer PDUs; Sequence numbering independent of the one in PDCP (UM and AM); Error Correction through ARQ (AM only); Segmentation (AM and UM) and re-segmentation (AM only) of RLC SDUs; Reassembly of SDU (AM and UM); Duplicate Detection (AM only); RLC SDU discard (AM and UM); RLC re-establishment; and Protocol error detection (AM only).

The automatic repeat request within the RLC 203 or RLC 213 sublayer may have the following characteristics: ARQ retransmits RLC SDUs or RLC SDU segments based on RLC status reports; Polling for RLC status report may be used when needed by RLC; RLC receiver may also trigger RLC status report after detecting a missing RLC SDU or RLC SDU segment.

The main services and functions of the PDCP 202 or PDCP 212 sublayer may include: Transfer of data (user plane or control plane); Maintenance of PDCP Sequence Numbers (SNs); Header compression and decompression using the Robust Header Compression (ROHC) protocol; Header compression and decompression using EHC protocol; Ciphering and deciphering; Integrity protection and integrity verification; Timer based SDU discard; Routing for split bearers; Duplication; Reordering and in-order delivery; Out-of-order delivery; and Duplicate discarding.

The main services and functions of SDAP 201 or SDAP 211 include: Mapping between a QoS flow and a data radio bearer; and Marking QoS Flow ID (QFI) in both downlink and uplink packets. A single protocol entity of SDAP may be configured for each individual PDU session.

As shown in FIG. 2B, the protocol stack of the control plane of the Uu interface (between the UE 125 and the gNB 115) includes PHY layer (layer 1), and MAC, RLC and PDCP sublayers of layer 2 as described above and in addition, the RRC 206 sublayer and RRC 216 sublayer. The main services and functions of the RRC 206 sublayer and the RRC 216 sublayer over the Uu interface include: Broadcast of System Information related to AS and NAS; Paging initiated by 5GC or NG-RAN; Establishment, maintenance and release of an RRC connection between the UE and NG-RAN (including Addition, modification and release of carrier aggregation; and Addition, modification and release of Dual Connectivity in NR or between E-UTRA and NR); Security functions including key management; Establishment, configuration, maintenance and release of SRBs and DRBs; Mobility functions (including Handover and context transfer; UE cell selection and reselection and control of cell selection and reselection; and Inter-RAT mobility); QoS management functions; UE measurement reporting and control of the reporting; Detection of and recovery from radio link failure; and NAS message transfer to/from NAS from/to UE. The NAS 207 and NAS 227 layer is a control protocol (terminated in AMF on the network side) that performs the functions such as authentication, mobility management, security control, etc.

The sidelink specific services and functions of the RRC sublayer over the Uu interface include: Configuration of sidelink resource allocation via system information or dedicated signaling; Reporting of UE sidelink information; Measurement configuration and reporting related to sidelink; and Reporting of UE assistance information for SL traffic pattern(s).

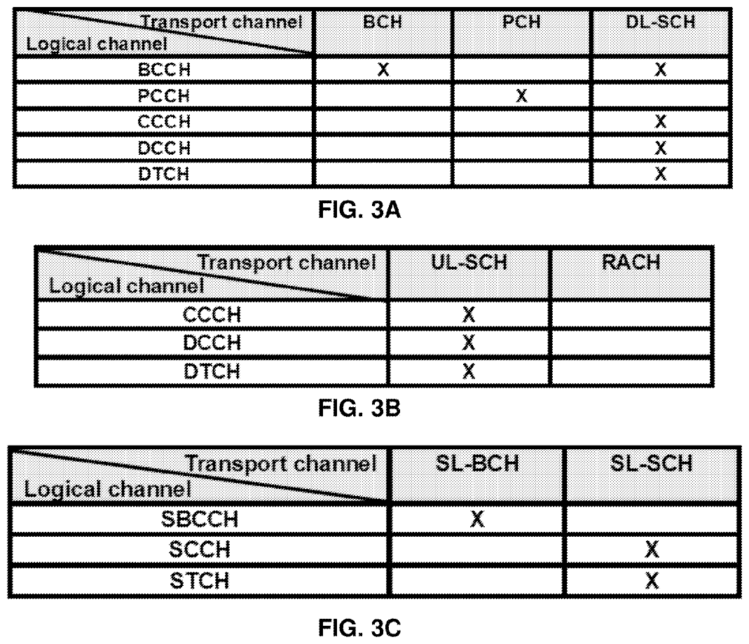

FIG. 3A, FIG. 3B and FIG. 3C show example mappings between logical channels and transport channels in downlink, uplink and sidelink, respectively, according to some aspects of some of various exemplary embodiments of the present disclosure. Different kinds of data transfer services may be offered by MAC. Each logical channel type may be defined by what type of information is transferred. Logical channels may be classified into two groups: Control Channels and Traffic Channels. Control channels may be used for the transfer of control plane information only. The Broadcast Control Channel (BCCH) is a downlink channel for broadcasting system control information. The Paging Control Channel (PCCH) is a downlink channel that carries paging messages. The Common Control Channel (CCCH) is channel for transmitting control information between UEs and networks. This channel may be used for UEs having no RRC connection with the network. The Dedicated Control Channel (DCCH) is a point-to-point bi-directional channel that transmits dedicated control information between a UE and the network and may be used by UEs having an RRC connection. Traffic channels may be used for the transfer of user plane information only. The Dedicated Traffic Channel (DTCH) is a point-to-point channel, dedicated to one UE, for the transfer of user information. A DTCH may exist in both uplink and downlink. Sidelink Control Channel (SCCH) is a sidelink channel for transmitting control information (e.g., PC5-RRC and PC5-S messages) from one UE to other UE(s). Sidelink Traffic Channel (STCH) is a sidelink channel for transmitting user information from one UE to other UE(s). Sidelink Broadcast Control Channel (SBCCH) is a sidelink channel for broadcasting sidelink system information from one UE to other UE(s).

The downlink transport channel types include Broadcast Channel (BCH), Downlink Shared Channel (DL-SCH), and Paging Channel (PCH). The BCH may be characterized by: fixed, pre-defined transport format; and requirement to be broadcast in the entire coverage area of the cell, either as a single message or by beamforming different BCH instances. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; and the support for UE Discontinuous Reception (DRX) to enable UE power saving. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; support for UE discontinuous reception (DRX) to enable UE power saving. The PCH may be characterized by: support for UE discontinuous reception (DRX) to enable UE power saving (DRX cycle is indicated by the network to the UE); requirement to be broadcast in the entire coverage area of the cell, either as a single message or by beamforming different BCH instances; mapped to physical resources which can be used dynamically also for traffic/other control channels.

In downlink, the following connections between logical channels and transport channels may exist: BCCH may be mapped to BCH; BCCH may be mapped to DL-SCH; PCCH may be mapped to PCH; CCCH may be mapped to DL-SCH; DCCH may be mapped to DL-SCH; and DTCH may be mapped to DL-SCH.

The uplink transport channel types include Uplink Shared Channel (UL-SCH) and Random Access Channel(s) (RACH). The UL-SCH may be characterized by possibility to use beamforming; support for dynamic link adaptation by varying the transmit power and potentially modulation and coding; support for HARQ; support for both dynamic and semi-static resource allocation. The RACH may be characterized by limited control information; and collision risk.

In Uplink, the following connections between logical channels and transport channels may exist: CCCH may be mapped to UL-SCH; DCCH may be mapped to UL-SCH; and DTCH may be mapped to UL-SCH.

The sidelink transport channel types include: Sidelink broadcast channel (SL-BCH) and Sidelink shared channel (SL-SCH). The SL-BCH may be characterized by pre-defined transport format. The SL-SCH may be characterized by support for unicast transmission, groupcast transmission and broadcast transmission; support for both UE autonomous resource selection and scheduled resource allocation by NG-RAN; support for both dynamic and semi-static resource allocation when UE is allocated resources by the NG-RAN; support for HARQ; and support for dynamic link adaptation by varying the transmit power, modulation and coding.

In the sidelink, the following connections between logical channels and transport channels may exist: SCCH may be mapped to SL-SCH; STCH may be mapped to SL-SCH; and SBCCH may be mapped to SL-BCH.

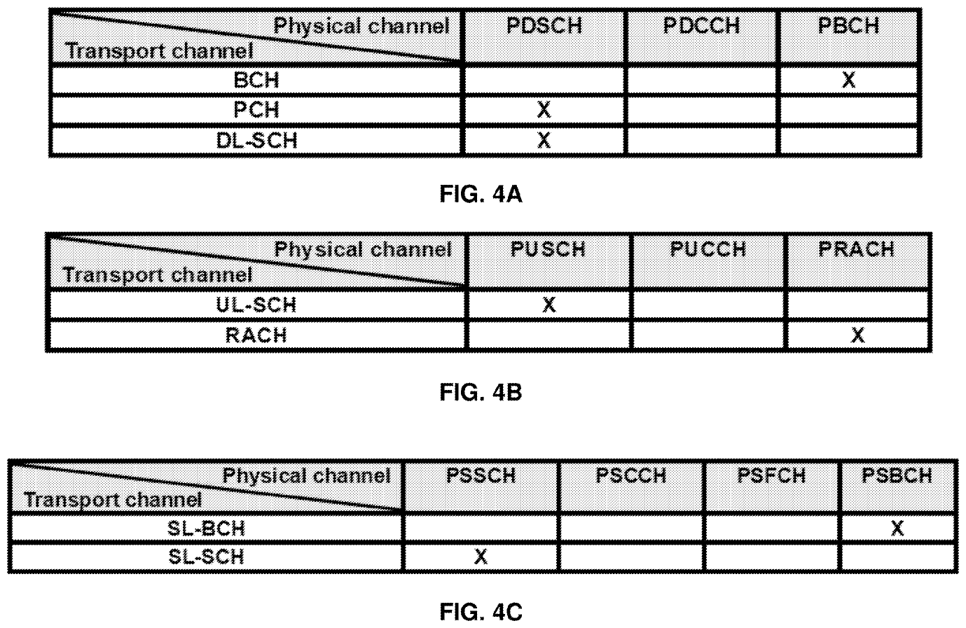

FIG. 4A, FIG. 4B and FIG. 4C show example mappings between transport channels and physical channels in downlink, uplink and sidelink, respectively, according to some aspects of some of various exemplary embodiments of the present disclosure. The physical channels in downlink include Physical Downlink Shared Channel (PDSCH), Physical Downlink Control Channel (PDCCH) and Physical Broadcast Channel (PBCH). The PCH and DL-SCH transport channels are mapped to the PDSCH. The BCH transport channel is mapped to the PBCH. A transport channel is not mapped to the PDCCH but Downlink Control Information (DCI) is transmitted via the PDCCH.

The physical channels in the uplink include Physical Uplink Shared Channel (PUSCH), Physical Uplink Control Channel (PUCCH) and Physical Random Access Channel (PRACH). The UL-SCH transport channel may be mapped to the PUSCH and the RACH transport channel may be mapped to the PRACH. A transport channel is not mapped to the PUCCH but Uplink Control Information (UCI) is transmitted via the PUCCH.

The physical channels in the sidelink include Physical Sidelink Shared Channel (PSSCH), Physical Sidelink Control Channel (PSCCH), Physical Sidelink Feedback Channel (PSFCH) and Physical Sidelink Broadcast Channel (PSBCH). The Physical Sidelink Control Channel (PSCCH) may indicate resource and other transmission parameters used by a UE for PSSCH. The Physical Sidelink Shared Channel (PSSCH) may transmit the TBs of data themselves, and control information for HARQ procedures and CSI feedback triggers, etc. At least 6 OFDM symbols within a slot may be used for PSSCH transmission. Physical Sidelink Feedback Channel (PSFCH) may carry the HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. The SL-SCH transport channel may be mapped to the PSSCH. The SL-BCH may be mapped to PSBCH. No transport channel is mapped to the PSFCH but Sidelink Feedback Control Information (SFCI) may be mapped to the PSFCH. No transport channel is mapped to PSCCH but Sidelink Control Information (SCI) may be mapped to the PSCCH.

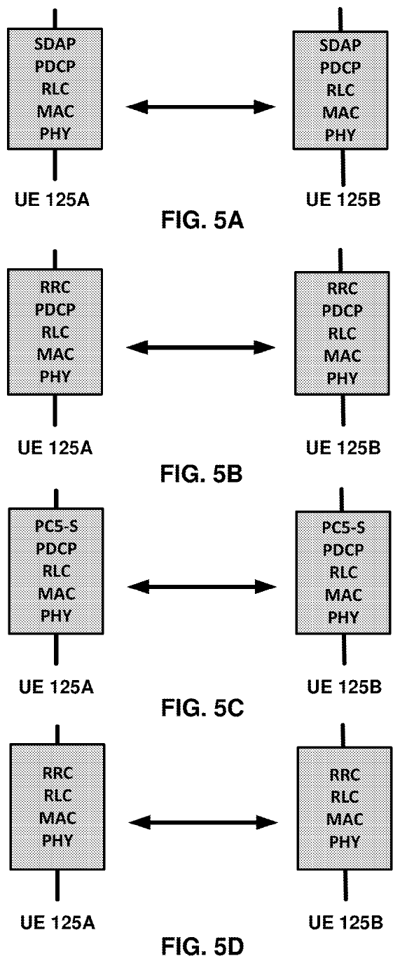

FIG. 5A, FIG. 5B, FIG. 5C and FIG. 5D show examples of radio protocol stacks for NR sidelink communication according to some aspects of some of various exemplary embodiments of the present disclosure. The AS protocol stack for user plane in the PC5 interface (i.e., for STCH) may consist of SDAP, PDCP, RLC and MAC sublayers, and the physical layer. The protocol stack of user plane is shown in FIG. 5A. The AS protocol stack for SBCCH in the PC5 interface may consist of RRC, RLC, MAC sublayers, and the physical layer as shown below in FIG. 5B. For support of PC5-S protocol, PC5-S is located on top of PDCP, RLC and MAC sublayers, and the physical layer in the control plane protocol stack for SCCH for PC5-S, as shown in FIG. 5C. The AS protocol stack for the control plane for SCCH for RRC in the PC5 interface consists of RRC, PDCP, RLC and MAC sublayers, and the physical layer. The protocol stack of control plane for SCCH for RRC is shown in FIG. 5D.

The Sidelink Radio Bearers (SLRBs) may be categorized into two groups: Sidelink Data Radio Bearers (SL DRB) for user plane data and Sidelink Signaling Radio Bearers (SL SRB) for control plane data. Separate SL SRBs using different SCCHs may be configured for PC5-RRC and PC5-S signaling, respectively.

The MAC sublayer may provide the following services and functions over the PC5 interface: Radio resource selection; Packet filtering; Priority handling between uplink and sidelink transmissions for a given UE; and Sidelink CSI reporting. With logical channel prioritization restrictions in MAC, only sidelink logical channels belonging to the same destination may be multiplexed into a MAC PDU for every unicast, groupcast and broadcast transmission which may be associated to the destination. For packet filtering, a SL-SCH MAC header including portions of both Source Layer-2 ID and a Destination Layer-2 ID may be added to a MAC PDU. The Logical Channel Identifier (LCID) included within a MAC subheader may uniquely identify a logical channel within the scope of the Source Layer-2 ID and Destination Layer-2 ID combination.

The services and functions of the RLC sublayer may be supported for sidelink. Both RLC Unacknowledged Mode (UM) and Acknowledged Mode (AM) may be used in unicast transmission while only UM may be used in groupcast or broadcast transmission. For UM, only unidirectional transmission may be supported for groupcast and broadcast.

The services and functions of the PDCP sublayer for the Uu interface may be supported for sidelink with some restrictions: Out-of-order delivery may be supported only for unicast transmission; and Duplication may not be supported over the PC5 interface.

The SDAP sublayer may provide the following service and function over the PC5 interface: Mapping between a QoS flow and a sidelink data radio bearer. There may be one SDAP entity per destination for one of unicast, groupcast and broadcast which is associated to the destination.

The RRC sublayer may provide the following services and functions over the PC5interface: Transfer of a PC5-RRC message between peer UEs; Maintenance and release of a PC5-RRC connection between two UEs; and Detection of sidelink radio link failure for a PC5-RRC connection based on indication from MAC or RLC. A PC5-RRC connection may be a logical connection between two UEs for a pair of Source and Destination Layer-2 IDs which may be considered to be established after a corresponding PC5 unicast link is established. There may be one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages may be used for a UE to transfer UE capability and sidelink configuration including SL-DRB configuration to the peer UE. Both peer UEs may exchange their own UE capability and sidelink configuration using separate bi-directional procedures in both sidelink directions.

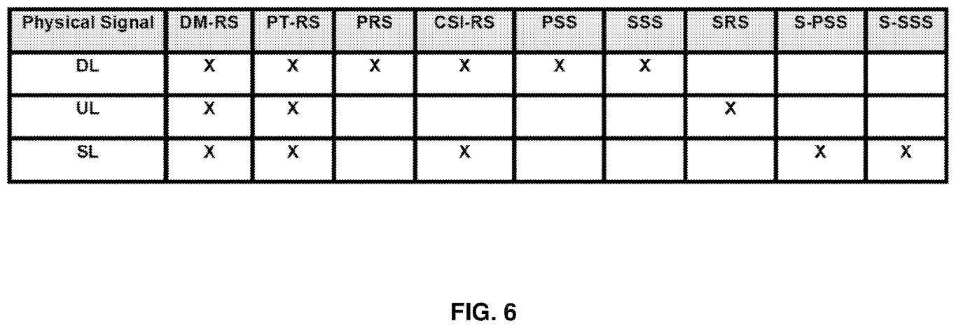

FIG. 6 shows example physical signals in downlink, uplink and sidelink according to some aspects of some of various exemplary embodiments of the present disclosure. The Demodulation Reference Signal (DM-RS) may be used in downlink, uplink and sidelink and may be used for channel estimation. DM-RS is a UE-specific reference signal and may be transmitted together with a physical channel in downlink, uplink or sidelink and may be used for channel estimation and coherent detection of the physical channel. The Phase Tracking Reference Signal (PT-RS) may be used in downlink, uplink and sidelink and may be used for tracking the phase and mitigating the performance loss due to phase noise. The PT-RS may be used mainly to estimate and minimize the effect of Common Phase Error (CPE) on system performance. Due to the phase noise properties, PT-RS signal may have a low density in the frequency domain and a high density in the time domain. PT-RS may occur in combination with DM-RS and when the network has configured PT-RS to be present. The Positioning Reference Signal (PRS) may be used in downlink for positioning using different positioning techniques. PRS may be used to measure the delays of the downlink transmissions by correlating the received signal from the base station with a local replica in the receiver. The Channel State Information Reference Signal (CSI-RS) may be used in downlink and sidelink. CSI-RS may be used for channel state estimation, Reference Signal Received Power (RSRP) measurement for mobility and beam management, time/frequency tracking for demodulation among other uses. CSI-RS may be configured UE-specifically but multiple users may share the same CSI-RS resource. The UE may determine CSI reports and transmit them in the uplink to the base station using PUCCH or PUSCH. The CSI report may be carried in a sidelink MAC CE. The Primary Synchronization Signal (PSS) and the Secondary Synchronization Signal (SSS) may be used for radio fame synchronization. The PSS and SSS may be used for the cell search procedure during the initial attachment or for mobility purposes. The Sounding Reference Signal (SRS) may be used in uplink for uplink channel estimation. Similar to CSI-RS, the SRS may serve as QCL reference for other physical channels such that they can be configured and transmitted quasi-collocated with SRS. The Sidelink PSS (S-PSS) and Sidelink SSS (S-SSS) may be used in sidelink for sidelink synchronization.

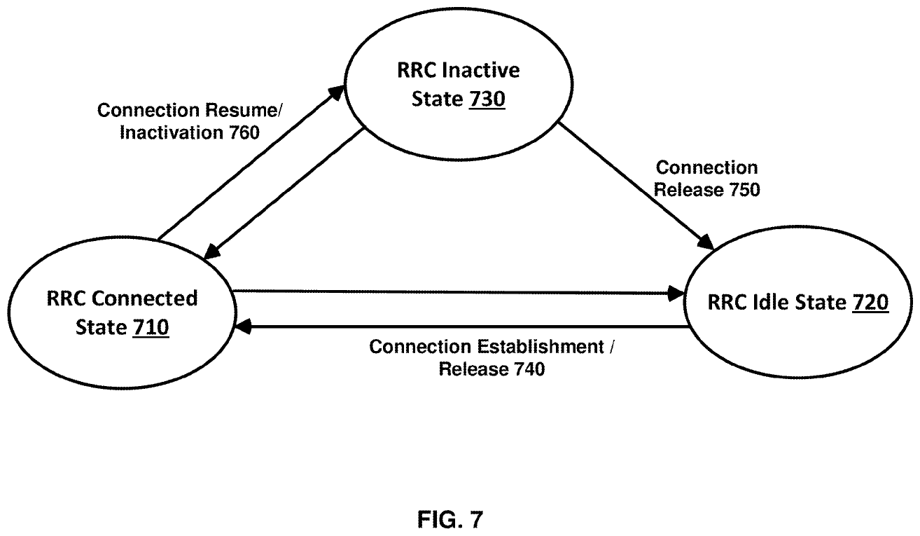

FIG. 7 shows examples of Radio Resource Control (RRC) states and transitioning between different RRC states according to some aspects of some of various exemplary embodiments of the present disclosure. A UE may be in one of three RRC states: RRC Connected State 710, RRC Idle State 720 and RRC Inactive state 730. After power up, the UE may be in RRC Idle state 720 and the UE may establish connection with the network using initial access and via an RRC connection establishment procedure to perform data transfer and/or to make/receive voice calls. Once RRC connection is established, the UE may be in RRC Connected State 710. The UE may transition from the RRC Idle state 720 to the RRC connected state 710 or from the RRC Connected State 710 to the RRC Idle state 720 using the RRC connection Establishment/Release procedures 740.

To reduce the signaling load and the latency resulting from frequent transitioning from the RRC Connected State 710 to the RRC Idle State 720 when the UE transmits frequent small data, the RRC Inactive State 730 may be used. In the RRC Inactive State 730, the AS context may be stored by both UE and gNB. This may result in faster state transition from the RRC Inactive State 730 to RRC Connected State 710. The UE may transition from the RRC Inactive State 730 to the RRC Connected State 710 or from the RRC Connected State 710 to the RRC Inactive State 730 using the RRC Connection Resume/Inactivation procedures 760. The UE may transition from the RRC Inactive State 730 to RRC Idle State 720 using an RRC Connection Release procedure 750.

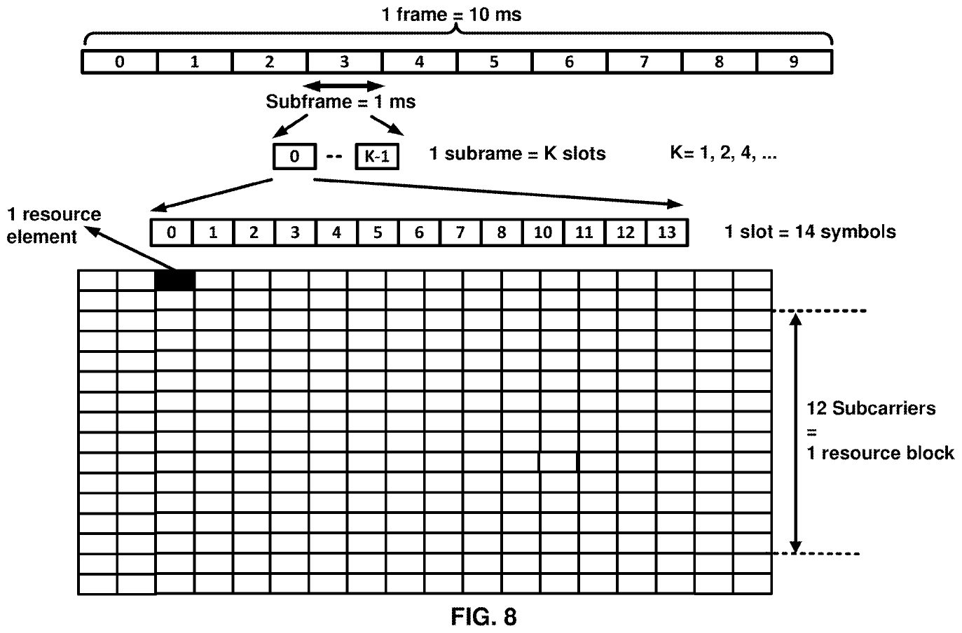

FIG. 8 shows example frame structure and physical resources according to some aspects of some of various exemplary embodiments of the present disclosure. The downlink or uplink or sidelink transmissions may be organized into frames with 10 ms duration, consisting of ten 1 ms subframes. Each subframe may consist of 1, 2, 4, . . . slots, wherein the number of slots per subframe may depend on the subcarrier spacing of the carrier on which the transmission takes place. The slot duration may be 14 symbols with Normal Cyclic Prefix (CP) and 12 symbols with Extended CP and may scale in time as a function of the used sub-carrier spacing so that there is an integer number of slots in a subframe. FIG. 8 shows a resource grid in time and frequency domain. Each element of the resource grid, comprising one symbol in time and one subcarrier in frequency, is referred to as a Resource Element (RE). A Resource Block (RB) may be defined as 12 consecutive subcarriers in the frequency domain.

In some examples and with non-slot-based scheduling, the transmission of a packet may occur over a portion of a slot, for example during 2, 4 or 7 OFDM symbols which may also be referred to as mini-slots. The mini-slots may be used for low latency applications such as URLLC and operation in unlicensed bands. In some embodiments, the mini-slots may also be used for fast flexible scheduling of services (e.g., pre-emption of URLLC over eMBB).

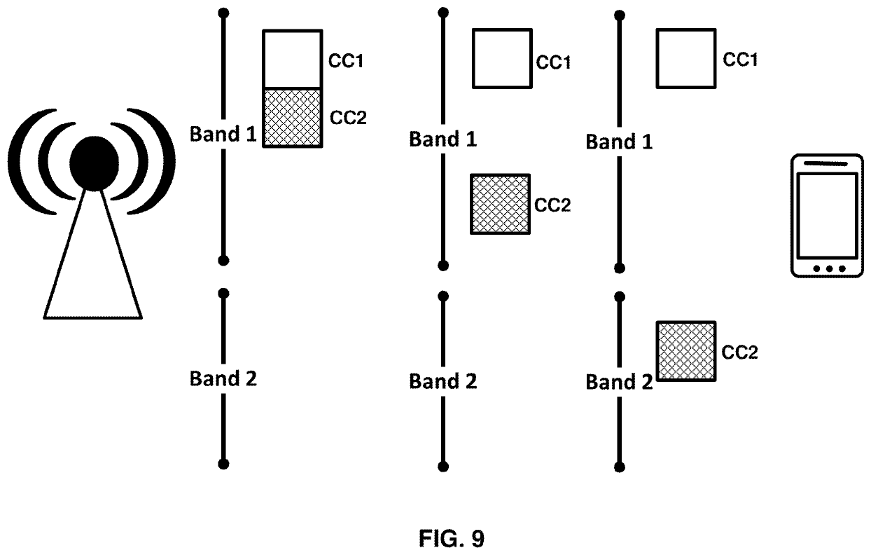

FIG. 9 shows example component carrier configurations in different carrier aggregation scenarios according to some aspects of some of various exemplary embodiments of the present disclosure. In Carrier Aggregation (CA), two or more Component Carriers (CCs) may be aggregated. A UE may simultaneously receive or transmit on one or multiple CCs depending on its capabilities. CA may be supported for both contiguous and non-contiguous CCs in the same band or on different bands as shown in FIG. 9. A gNB and the UE may communicate using a serving cell. A serving cell may be associated with at least with one downlink CC (e.g., may be associated only with one downlink CC or may be associated with a downlink CC and an uplink CC). A serving cell may be a Primary Cell (PCell) or a Secondary cCell (SCell).

A UE may adjust the timing of its uplink transmissions using an uplink timing control procedure. A Timing Advance (TA) may be used to adjust the uplink frame timing relative to the downlink frame timing. The gNB may determine the desired Timing Advance setting and provides that to the UE. The UE may use the provided TA to determine its uplink transmit timing relative to the UE's observed downlink receive timing.

In the RRC Connected state, the gNB may be responsible for maintaining the timing advance to keep the L1 synchronized. Serving cells having uplink to which the same timing advance applies and using the same timing reference cell are grouped in a Timing Advance Group (TAG). A TAG may contain at least one serving cell with configured uplink. The mapping of a serving cell to a TAG may be configured by RRC. For the primary TAG, the UE may use the PCell as timing reference cell, except with shared spectrum channel access where an SCell may also be used as timing reference cell in certain cases. In a secondary TAG, the UE may use any of the activated SCells of this TAG as a timing reference cell and may not change it unless necessary.

Timing advance updates may be signaled by the gNB to the UE via MAC CE commands. Such commands may restart a TAG-specific timer which may indicate whether the L1 can be synchronized or not: when the timer is running, the L1 may be considered synchronized, otherwise, the L1 may be considered non-synchronized (in which case uplink transmission may only take place on PRACH).

A UE with single timing advance capability for CA may simultaneously receive and/or transmit multiple CCs corresponding to multiple serving cells sharing the same timing advance (multiple serving cells grouped in one TAG). A UE with multiple timing advance capability for CA may simultaneously receive and/or transmit on multiple CCs corresponding to multiple serving cells with different timing advances (multiple serving cells grouped in multiple TAGs). The NG-RAN may ensure that each TAG contains at least one serving cell. A non-CA capable UE may receive on a single CC and may transmit on a single CC corresponding to one serving cell only (one serving cell in one TAG).

The multi-carrier nature of the physical layer in case of CA may be exposed to the MAC layer and one HARQ entity may be required per serving cell. When CA is configured, the UE may have one RRC connection with the network. At RRC connection establishment/re-establishment/handover, one serving cell (e.g., the PCell) may provide the NAS mobility information. Depending on UE capabilities, SCells may be configured to form together with the PCell a set of serving cells. The configured set of serving cells for a UE may consist of one PCell and one or more SCells. The reconfiguration, addition and removal of SCells may be performed by RRC.

In a dual connectivity scenario, a UE may be configured with a plurality of cells comprising a Master Cell Group (MCG) for communications with a master base station, a Secondary Cell Group (SCG) for communications with a secondary base station, and two MAC entities: one MAC entity and for the MCG for communications with the master base station and one MAC entity for the SCG for communications with the secondary base station.

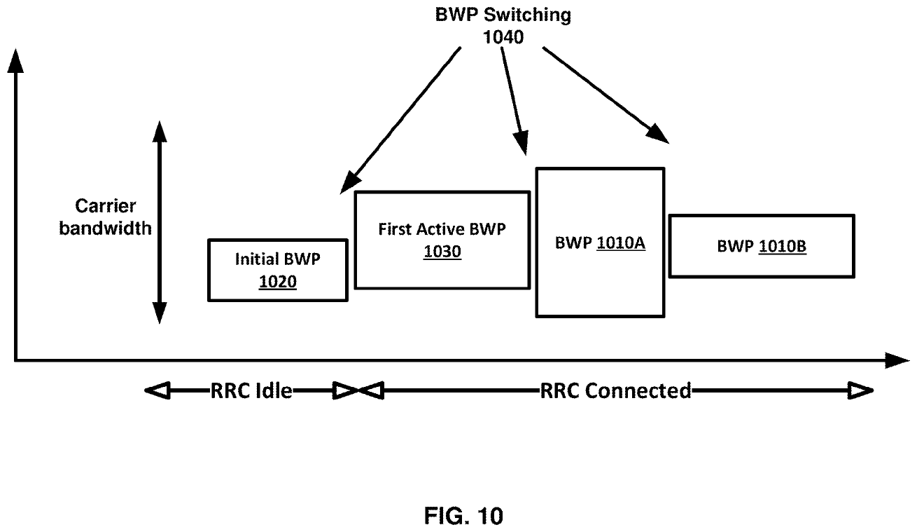

FIG. 10 shows example bandwidth part configuration and switching according to some aspects of some of various exemplary embodiments of the present disclosure. The UE may be configured with one or more Bandwidth Parts (BWPs) 1010 on a given component carrier. In some examples, one of the one or more bandwidth parts may be active at a time. The active bandwidth part may define the UE's operating bandwidth within the cell's operating bandwidth. For initial access, and until the UE's configuration in a cell is received, initial bandwidth part 1020 determined from system information may be used. With Bandwidth Adaptation (BA), for example through BWP switching 1040, the receive and transmit bandwidth of a UE may not be as large as the bandwidth of the cell and may be adjusted. For example, the width may be ordered to change (e.g., to shrink during period of low activity to save power); the location may move in the frequency domain (e.g., to increase scheduling flexibility); and the subcarrier spacing may be ordered to change (e.g., to allow different services). The first active BWP 1020 may be the active BWP upon RRC (re-)configuration for a PCell or activation of an SCell.

For a downlink BWP or uplink BWP in a set of downlink BWPs or uplink BWPs, respectively, the UE may be provided the following configuration parameters: a Subcarrier Spacing (SCS); a cyclic prefix; a common RB and a number of contiguous RBs; an index in the set of downlink BWPs or uplink BWPs by respective BWP-Id; a set of BWP-common and a set of BWP-dedicated parameters. A BWP may be associated with an OFDM numerology according to the configured subcarrier spacing and cyclic prefix for the BWP. For a serving cell, a UE may be provided by a default downlink BWP among the configured downlink BWPs. If a UE is not provided a default downlink BWP, the default downlink BWP may be the initial downlink BWP.

A downlink BWP may be associated with a BWP inactivity timer. If the BWP inactivity timer associated with the active downlink BWP expires and if the default downlink BWP is configured, the UE may perform BWP switching to the default BWP. If the BWP inactivity timer associated with the active downlink BWP expires and if the default downlink BWP is not configured, the UE may perform BWP switching to the initial downlink BWP.

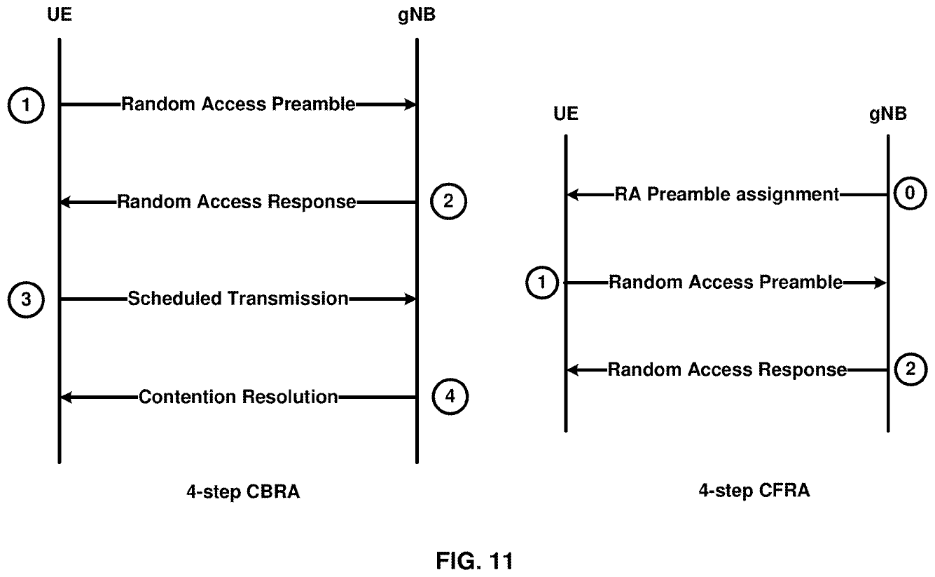

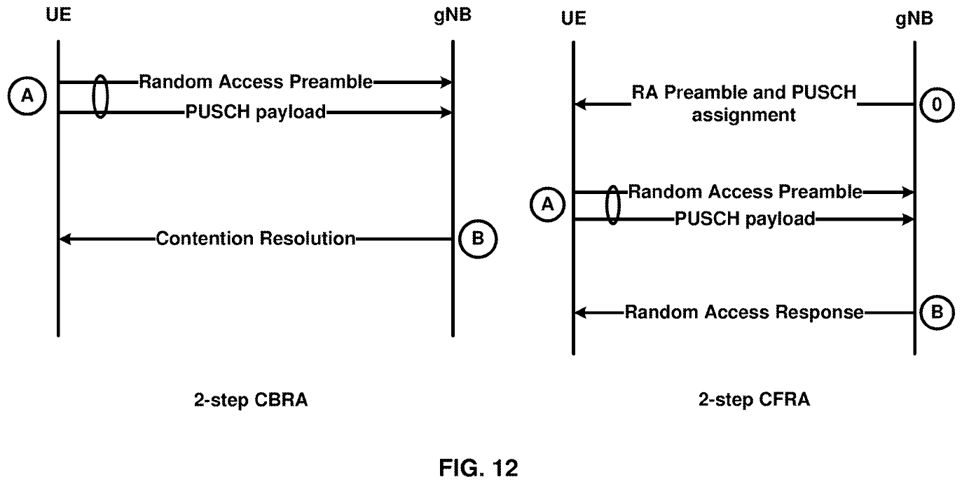

FIG. 11 shows example four-step contention-based and contention-free random access processes according to some aspects of some of various exemplary embodiments of the present disclosure. FIG. 12 shows example two-step contention-based and contention-free random access processes according to some aspects of some of various exemplary embodiments of the present disclosure. The random access procedure may be triggered by a number of events, for example: Initial access from RRC Idle State; RRC Connection Re-establishment procedure; downlink or uplink data arrival during RRC Connected State when uplink synchronization status is “non-synchronized”; uplink data arrival during RRC Connected State when there are no PUCCH resources for Scheduling Request (SR) available; SR failure; Request by RRC upon synchronous reconfiguration (e.g. handover); Transition from RRC Inactive State; to establish time alignment for a secondary TAG; Request for Other System Information (SI); Beam Failure Recovery (BFR); Consistent uplink Listen-Before-Talk (LBT) failure on PCell.

Two types of Random Access (RA) procedure may be supported: 4-step RA type with MSG1 and 2-step RA type with MSGA. Both types of RA procedure may support Contention-Based Random Access (CBRA) and Contention-Free Random Access (CFRA) as shown in FIG. 11 and FIG. 12.

The UE may select the type of random access at initiation of the random access procedure based on network configuration. When CFRA resources are not configured, an RSRP threshold may be used by the UE to select between 2-step RA type and 4-step RA type. When CFRA resources for 4-step RA type are configured, UE may perform random access with 4-step RA type. When CFRA resources for 2-step RA type are configured, UE may perform random access with 2-step RA type.

The MSG1 of the 4-step RA type may consist of a preamble on PRACH. After MSG1 transmission, the UE may monitor for a response from the network within a configured window. For CFRA, dedicated preamble for MSG1 transmission may be assigned by the network and upon receiving Random Access Response (RAR) from the network, the UE may end the random access procedure as shown in FIG. 11. For CBRA, upon reception of the random access response, the UE may send MSG3 using the uplink grant scheduled in the random access response and may monitor contention resolution as shown in FIG. 11. If contention resolution is not successful after MSG3 (re)transmission(s), the UE may go back to MSG1 transmission.

The MSGA of the 2-step RA type may include a preamble on PRACH and a payload on PUSCH. After MSGA transmission, the UE may monitor for a response from the network within a configured window. For CFRA, dedicated preamble and PUSCH resource may be configured for MSGA transmission and upon receiving the network response, the UE may end the random access procedure as shown in FIG. 12. For CBRA, if contention resolution is successful upon receiving the network response, the UE may end the random access procedure as shown in FIG. 12; while if fallback indication is received in MSGB, the UE may perform MSG3 transmission using the uplink grant scheduled in the fallback indication and may monitor contention resolution. If contention resolution is not successful after MSG3 (re)transmission(s), the UE may go back to MSGA transmission.

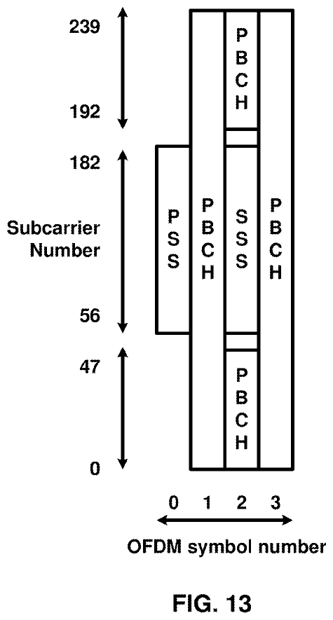

FIG. 13 shows example time and frequency structure of Synchronization Signal and Physical Broadcast Channel (PBCH) Block (SSB) according to some aspects of some of various exemplary embodiments of the present disclosure. The SS/PBCH Block (SSB) may consist of Primary and Secondary Synchronization Signals (PSS, SSS), each occupying 1 symbol and 127 subcarriers (e.g., subcarrier numbers 56 to 182 in FIG. 13), and PBCH spanning across 3 OFDM symbols and 240 subcarriers, but on one symbol leaving an unused part in the middle for SSS as show in FIG. 13. The possible time locations of SSBs within a half-frame may be determined by sub-carrier spacing and the periodicity of the half-frames, where SSBs are transmitted, may be configured by the network. During a half-frame, different SSBs may be transmitted in different spatial directions (i.e., using different beams, spanning the coverage area of a cell).

The PBCH may be used to carry Master Information Block (MIB) used by a UE during cell search and initial access procedures. The UE may first decode PBCH/MIB to receive other system information. The MIB may provide the UE with parameters required to acquire System Information Block 1 (SIB1), more specifically, information required for monitoring of PDCCH for scheduling PDSCH that carries SIB1. In addition, MIB may indicate cell barred status information. The MIB and SIB1 may be collectively referred to as the minimum system information (SI) and SIB1 may be referred to as remaining minimum system information (RMSI). The other system information blocks (SIBs) (e.g., SIB2, SIB3, . . . , SIB10 and SIBpos) may be referred to as Other SI. The Other SI may be periodically broadcast on DL-SCH, broadcast on-demand on DL-SCH (e.g., upon request from UEs in RRC Idle State, RRC Inactive State, or RRC connected State), or sent in a dedicated manner on DL-SCH to UEs in RRC Connected State (e.g., upon request, if configured by the network, from UEs in RRC Connected State or when the UE has an active BWP with no common search space configured).

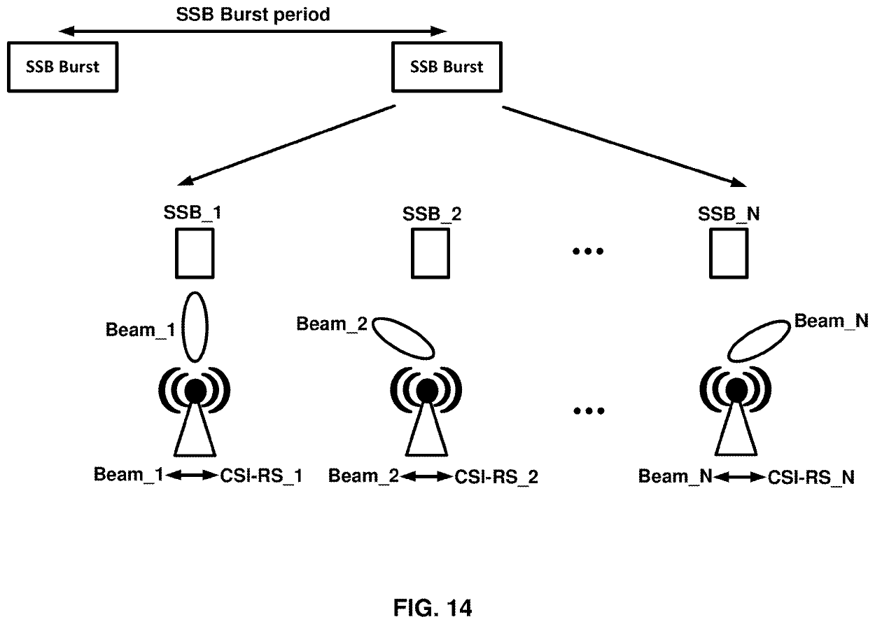

FIG. 14 shows example SSB burst transmissions according to some aspects of some of various exemplary embodiments of the present disclosure. An SSB burst may include N SSBs and each SSB of the N SSBs may correspond to a beam. The SSB bursts may be transmitted according to a periodicity (e.g., SSB burst period). During a contention-based random access process, a UE may perform a random access resource selection process, wherein the UE first selects an SSB before selecting a RA preamble. The UE may select an SSB with an RSRP above a configured threshold value. In some embodiments, the UE may select any SSB if no SSB with RSRP above the configured threshold is available. A set of random access preambles may be associated with an SSB. After selecting an SSB, the UE may select a random access preamble from the set of random access preambles associated with the SSB and may transmit the selected random access preamble to start the random access process.

In some embodiments, a beam of the N beams may be associated with a CSI-RS resource. A UE may measure CSI-RS resources and may select a CSI-RS with RSRP above a configured threshold value. The UE may select a random access preamble corresponding to the selected CSI-RS and may transmit the selected random access process to start the random access process. If there is no random access preamble associated with the selected CSI-RS, the UE may select a random access preamble corresponding to an SSB which is Quasi-Collocated with the selected CSI-RS.

In some embodiments, based on the UE measurements of the CSI-RS resources and the UE CSI reporting, the base station may determine a Transmission Configuration Indication (TCI) state and may indicate the TCI state to the UE, wherein the UE may use the indicated TCI state for reception of downlink control information (e.g., via PDCCH) or data (e.g., via PDSCH). The UE may use the indicated TCI state for using the appropriate beam for reception of data or control information. The indication of the TCI states may be using RRC configuration or in combination of RRC signaling and dynamic signaling (e.g., via a MAC Control element (MAC CE) and/or based on a value of field in the downlink control information that schedules the downlink transmission). The TCI state may indicate a Quasi-Colocation (QCL) relationship between a downlink reference signal such as CSI-RS and the DM-RS associated with the downlink control or data channels (e.g., PDCCH or PDSCH, respectively).

In some embodiments, the UE may be configured with a list of up to M TCI-State configurations, using Physical Downlink Shared Channel (PDSCH) configuration parameters, to decode PDSCH according to a detected PDCCH with DCI intended for the UE and the given serving cell, where M may depend on the UE capability. Each TCI-State may contain parameters for configuring a QCL relationship between one or two downlink reference signals and the DM-RS ports of the PDSCH, the DM-RS port of PDCCH or the CSI-RS port(s) of a CSI-RS resource. The quasi co-location relationship may be configured by one or more RRC parameters. The quasi co-location types corresponding to each DL RS may take one of the following values: ‘QCL-TypeA’: {Doppler shift, Doppler spread, average delay, delay spread}; ‘QCL-TypeB’: {Doppler shift, Doppler spread}; ‘QCL-TypeC’: {Doppler shift, average delay}; ‘QCL-TypeD’: {Spatial Rx parameter}. The UE may receive an activation command (e.g., a MAC CE), used to map TCI states to the codepoints of a DCI field.

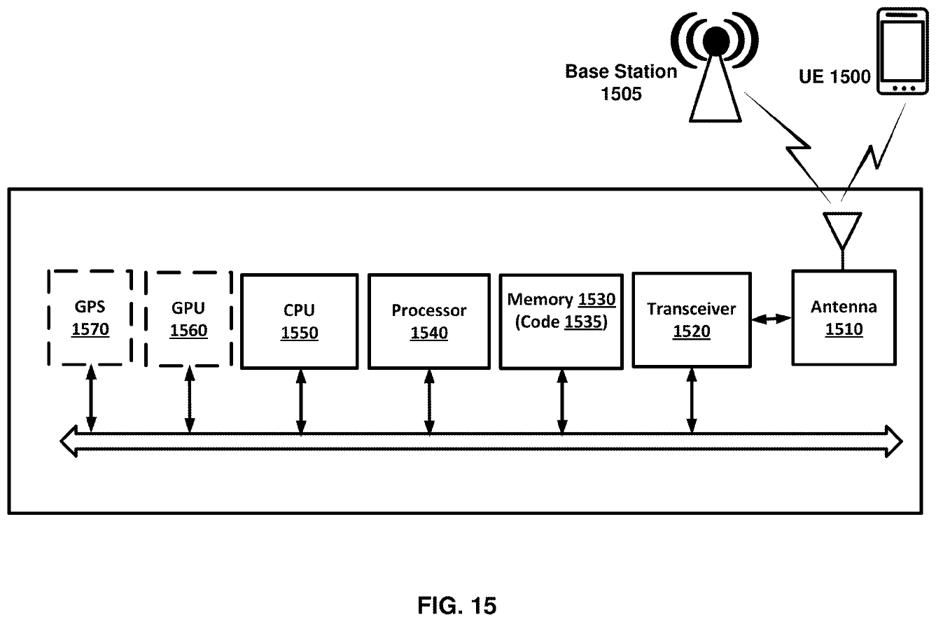

FIG. 15 shows example components of a user equipment and a base station for transmission and/or reception according to some aspects of some of various exemplary embodiments of the present disclosure. All or a subset of blocks and functions in FIG. 15 may be in the base station 1505 and the user equipment 1500 and may be performed by the user equipment 1500 and by the base station 1505. The Antenna 1510 may be used for transmission or reception of electromagnetic signals. The Antenna 1510 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 150 may enable a massive MIMO configuration with tens or hundreds of antenna elements. The Antenna 1510 may enable other multi-antenna techniques such as beamforming. In some examples, depending on the UE 1500 capabilities or the type of UE 1500 (e.g., a low-complexity UE), the UE 1500 may support a single antenna only.

The transceiver 1520 may communicate bi-directionally, via the Antenna 1510, wireless links as described herein. For example, the transceiver 1520 may represent a wireless transceiver at the UE and may communicate bi-directionally with the wireless transceiver at the base station or vice versa. The transceiver 1520 may include a modem to modulate the packets and provide the modulated packets to the Antennas 1510 for transmission, and to demodulate packets received from the Antennas 1510.

The memory 1530 may include RAM and ROM. The memory 1530 may store computer-readable, computer-executable code 1535 including instructions that, when executed, cause the processor to perform various functions described herein. In some examples, the memory 1530 may contain, among other things, a Basic Input/output System (BIOS) which may control basic hardware or software operation such as the interaction with peripheral components or devices.

The processor 1540 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1540 may be configured to operate a memory using a memory controller. In other examples, a memory controller may be integrated into the processor 1540. The processor 1540 may be configured to execute computer-readable instructions stored in a memory (e.g., the memory 1530) to cause the UE 1500 or the base station 1505 to perform various functions.

The Central Processing Unit (CPU) 1550 may perform basic arithmetic, logic, controlling, and Input/output (I/O) operations specified by the computer instructions in the Memory 1530. The user equipment 1500 and/or the base station 1505 may include additional peripheral components such as a graphics processing unit (GPU) 1560 and a Global Positioning System (GPS) 1570. The GPU 1560 is a specialized circuitry for rapid manipulation and altering of the Memory 1530 for accelerating the processing performance of the user equipment 1500 and/or the base station 1505. The GPS 1570 may be used for enabling location-based services or other services for example based on geographical position of the user equipment 1500.

In example embodiments, a MAC PDU may be a bit string that is byte aligned (e.g., multiple of 8 bits) in length. The bit strings may be represented by tables in which the most significant bit is the leftmost bit of the first line of the table, the least significant bit is the rightmost bit on the last line of the table, and more generally the bit string may be to be read from left to right and then in the reading order of the lines. The bit order of each parameter field within a MAC PDU is represented with the first and most significant bit in the leftmost bit and the last and least significant bit in the rightmost bit. A MAC SDU may be a bit string that is byte aligned (e.g., multiple of 8 bits) in length. A MAC SDU may be included into a MAC PDU from the first bit onward. A MAC CE may be a bit string that is byte aligned (e.g., multiple of 8 bits) in length. A MAC subheader may be a bit string that is byte aligned (e.g., multiple of 8 bits) in length. Each MAC subheader may be placed immediately in front of the corresponding MAC SDU, MAC CE, or padding. The MAC entity may ignore the value of the Reserved bits in downlink MAC PDUs.

In example embodiments, a MAC PDU may comprise one or more MAC subPDUs. Each MAC subPDU may comprise of one of the following: a MAC subheader only (including padding); a MAC subheader and a MAC SDU; a MAC subheader and a MAC CE; a MAC subheader and padding. In some examples, the MAC SDUs may be of variable sizes. A MAC subheader may correspond to either a MAC SDU, a MAC CE, or padding.

A MAC subheader except for fixed sized MAC CE, padding, and a MAC SDU containing UL CCCH may comprise the header fields R/F/LCID/(eLCID)/L. A MAC subheader for fixed sized MAC CE, padding, and a MAC SDU containing UL CCCH may comprise the two header fields R/LCID/(eLCID).

In example embodiments, MAC CEs may be placed together. DL MAC subPDU(s) with MAC CE(s) may be placed before any MAC subPDU with MAC SDU and MAC subPDU with padding. UL MAC subPDU(s) with MAC CE(s) may be placed after the MAC subPDU(s) with MAC SDU and before the MAC subPDU with padding in the MAC PDU. The size of padding may be zero. A maximum of one MAC PDU may be transmitted per TB per MAC entity.

In example embodiments, a MAC subheader may comprise one or more of the following fields: LCID, eLCID, L field and F field. The Logical Channel ID (LCID) field may identify the logical channel instance of the corresponding MAC SDU or the type of the corresponding MAC CE or padding for the DL-SCH and UL-SCH respectively. There may be one LCID field per MAC subheader. The size of the LCID field may be 6 bits. If the LCID field is set to 34, one additional octet may be present in the MAC subheader containing the eLCID field and follow the octet containing LCID field. If the LCID field is set to 33, two additional octets may be present in the MAC subheader containing the eLCID field and these two additional octets may follow the octet containing LCID field. For MBS broadcast, a logical channel may be identified based on G-RNTI and LCID if the same LCID is allocated for logical channels corresponding to different G-RNTIs. The extended Logical Channel ID (eLCID) field may identify the logical channel instance of the corresponding MAC SDU or the type of the corresponding MAC CE for the DL-SCH and UL-SCH respectively. The size of the eLCID field may be either 8 bits or 16 bits. The Length (L) field may indicate the length of the corresponding MAC SDU or variable-sized MAC CE in bytes. There may be one L field per MAC subheader except for subheaders corresponding to fixed-sized MAC CEs, padding, and MAC SDUs containing UL CCCH. The size of the L field may be indicated by the F field. The Format (F) field may indicate the size of the Length field. There may be one F field per MAC subheader except for subheaders corresponding to fixed-sized MAC CEs, padding, and MAC SDUs containing UL CCCH. The size of the F field may be 1 bit. The value 0 may indicate 8 bits of the Length field. The value 1 may indicate 16 bits of the Length field. The MAC subheader may be octet aligned.

In some examples, a Non-Terrestrial Network (NTN) may provide non-terrestrial NR access to a UE by means of an NTN payload and an NTN Gateway. A service link may exist between the NTN payload and a UE, and a feeder link may exist between the NTN Gateway and the NTN payload.

In some examples, the NTN payload may transparently forward the radio protocol received from the UE (via the service link) to the NTN Gateway (via the feeder link) and vice-versa. The following connectivity may be supported by the NTN payload: A gNB may serve multiple NTN payloads; An NTN payload may be served by multiple gNBs.

In some examples, the NTN-payload may change the carrier frequency, before re-transmitting it on the service link, and vice versa (respectively on the feeder link).

In some examples, for NTN, the following may apply in addition to Network Identities: A Tracking Area may correspond to a fixed geographical area. A respective mapping may be configured in the RAN; A Mapped Cell ID.

In some examples, Non-Geosynchronous orbit (NGSO) may include Low Earth Orbit at altitude approximately between 300 km and 1500 km and Medium Earth Orbit at altitude approximately between 7000 km and 25000 km.

In some examples, three types of service links may be supported: Earth-fixed: provisioned by beam(s) continuously covering the same geographical areas all the time (e.g., the case of GSO satellites); Quasi-Earth-fixed: provisioned by beam(s) covering one geographic area for a limited period and a different geographic area during another period (e.g., the case of NGSO satellites generating steerable beams); Earth-moving: provisioned by beam(s) whose coverage area slides over the Earth surface (e.g., the case of NGSO satellites generating fixed or non-steerable beams).

In some examples, with NGSO satellites, the gNB may provide either quasi-Earth-fixed cell coverage or Earth-moving cell coverage, while gNB operating with GSO satellite may provide Earth fixed cell coverage. In some examples, the UE supporting NTN may be GNSS-capable.

In some examples, in the case of NGSO, service link switch may refer to a change of serving satellite.

In some examples, the UE may be configured to report the UE's Timing Advance: during Random Access procedure in Idle/Inactive state; in connected mode: using event-triggered reporting; for RRC re-establishment procedure, if an indication is broadcasted by the target cell's SI; for handover, the UE should trigger TA report if the target cell indicates this in the handover command.

In some examples, to accommodate the long propagation delay, User Plane procedures may be adapted as follow: for downlink, HARQ feedback can be enabled or disabled per HARQ process; for uplink, the UE may be configured with a HARQ mode A or B per HARQ process; maximum number of HARQ processes may be extended to 32; the value ranges of MAC (e.g., sr-ProhibitTimer and configuredGrantTimer), RLC (i.e. t-Reassembly) and PDCP (i.e. discardTimer and t-reordering) layer timers may be extended.

In some examples, it may be up to network implementation to ensure proper configuration of HARQ feedback (e.g., enabled or disabled) for HARQ processes used by an SPS configuration and of HARQ mode for HARQ processes used by a CG configuration.

In some examples, if a logical channel is configured with allowedHARQ-mode, it may be mapped to a HARQ process with the same HARQ mode.

In some examples, to accommodate the long propagation delays, several NR timings involving DL-UL timing interaction may be enhanced by the support of two scheduling offsets: K_{offset} and k_{mac}.

In some examples, the timing relationships that need to be modified for NTN using Koffset may be: the transmission timing of DCI scheduled PUSCH, including channel state information (CSI) transmission on PUSCH; the transmission timing of random access response (RAR) grant or fallbackRAR grant scheduled PUSCH; the timing of the first PUSCH transmission opportunity in type-2 configured grant; the transmission timing of HARQ-ACK on physical uplink control channel (PUCCH), including HARQ-ACK on PUCCH to message B (MsgB) in 2-step random access; the transmission timing of PDCCH ordered physical random access channel (PRACH); the timing of the adjustment of uplink transmission timing upon reception of a corresponding timing advance command; the transmission timing of aperiodic sounding reference signal (SRS); the CSI reference resource timing.

In some examples, upon network request, after AS security in connected mode is established, a UE may report coarse UE location information (e.g., X most Significant Bits of its GNSS coordinates with accuracy around 2 km level) to the NG-RAN without receiving any prior explicit user consent. if “user consent” is available at the UE, the UE may report the coarse UE location information. Otherwise, the UE may respond “no coarse GNSS location available”. Periodic location reporting may be configured by gNB to obtain UE location update of mobile UEs in RRC_CONNECTED. This proposed text may be updated upon SA3 feedback.

In some examples, disabling HARQ feedback may be used to mitigate impact of HARQ stalling on UE data rates.

In some examples, enabling/disabling HARQ feedback for downlink transmission may be at least configurable per HARQ process via UE specific RRC signaling.

In some examples, for a DL HARQ process with disabled HARQ feedback, the UE may not be expected to receive another PDSCH or set of slot-aggregated PDSCH scheduled for the given HARQ process that may start until X after the end of the reception of the last PDSCH or slot-aggregated PDSCH for that HARQ process. In some examples, X=T_proc,1. In some examples, X may be X=max(T_proc,1, K1) where K1 may be the minimum k1 if it is configured, otherwise k1=0. In some examples, the TB of the two PDSCHs may be either same or different.

In some examples, X=T_proc,1 where X may be defined from the end of the reception of the last PDSCH or slot-aggregated PDSCH for a given HARQ process with disabled feedback to the start of the PDCCH carrying the DCI scheduling another PDSCH or set of slot-aggregated PDSCH for the given HARQ process.

In some examples, for HARQ feedback of each SPS PDSCH, UE may follow the per-process configuration of HARQ feedback enabled/disabled for the associated HARQ process, except for the first SPS PDSCH after activation if HARQ feedback for SPS activation is additionally enabled.

In some examples, enabling/disabling HARQ feedback may be configurable per HARQ process via UE specific RRC signaling in NR-NTN. In some examples, when HARQ feedback is disabled, PDCCH monitoring and SPS activation may be enhanced.

In some examples, enabling/disabling HARQ feedback for downlink transmission may be configurable per HARQ process via UE specific RRC signaling.

In some examples, the enabling/disabling HARQ feedback in IoT-NTN based on repetition number for each transmission may be supported.

In some examples, when HARQ feedback for a HARQ process is enabled, the UE may not be expected to receive another NPDCCH/MPDCCH carrying a DCI scheduling a NPDSCH/PDSCH scheduled for the given HARQ process that starts until round trip propagation delay after the end of the transmit of HARQ-ACK.

In some examples, there may be potentially large throughput impact of HARQ stalling, originating from the large RTT delay. In some examples, HARQ disabling may be used to overcome HARQ stalling.

In some examples, for non-terrestrial networking (NTN), the round trip time (RTT) delay varies from tens to hundreds of milliseconds, which may be lengthy compared to terrestrial networks. To accommodate long RTT and minimize the throughput loss, maximal supported HARQ processes number may be extended (e.g., to 32 for both UL and DL) and/or feedback of some HARQ processes may be disabled in NR NTN.

In some examples, for IoT NTN with disabling HARQ mechanism, the peak rate for different scenarios may be increased.

In some examples, when repetition is taken into consideration, the stalling issues may not exist when UE is configured with 2 HARQ processes and each HARQ process schedules one TB as the NPDSCH scheduling by the second HARQ process may fill the stalling of the NPDSCH scheduling by the first HARQ process.

In some examples in IoT NTN, the maximum data rate may be impacted in the case when large number of repetition is used for link budget improvement.

In some examples, HARQ disabling for NR-NTN may be supported. The HARQ disabling may bring the following advantages: UE power saving, throughput increase without increasing UE complexity, improved resource utilization. In some examples, the main benefit to support HARQ disabling may be to resolve the HARQ stalling issue.

In some examples, HARQ stalling issue may happen when the IoT UEs are configured with only one HARQ process.

In some examples, HARQ stalling issue may happen when the IoT UEs are configured with more than one HARQ process.

In some examples, the HARQ disabling may be supported for at least for the IoT UE that is only configured/capable of single HARQ process.

In some examples, the HARQ disabling may be configured by RRC signaling. For the transmission of the important information, the HARQ enabled process may be used. For the IoT device that is configured/capable of only one HARQ process, the semi-static configuration may not be flexible to guarantee the reception reliability of the important information. The dynamic HARQ disabling may be supported.

In some examples, dynamic HARQ disabling may be supported at least for the IoT UE configured/capable of one HARQ process.

In some examples, disabling HARQ feedback for DL transmission may enable avoidance of HARQ stalling due to a long round-trip time. The transmission time of available HARQ processes may not fill up the round trip propagation time between the UE and base station, causing HARQ stalling and limiting UE throughput in normal HARQ operation. Although it has been pointed out that the base station may schedule a new transport block without waiting for the ACK/NACK to arrive, it may not provide similar effect as HARQ feedback disabling. Furthermore, UE may save the power of HARQ feedback transmission. Furthermore, more UL data transmission could be scheduled on the resource that would have been used for HARQ feedback, resulting in higher UL throughput. Furthermore, for half-duplex UE, more DL scheduling opportunity may be created without HARQ feedback in the UL, which may increase DL throughput.

In some examples, enabling/disabling HARQ feedback for downlink transmission may be at least configurable per HARQ process via UE specific RRC signaling.

In some examples, when HARQ feedback is disabled, alternative long-term feedback may be considered to facilitate link adaptation.

HARQ feedback enablement/disablement has been considered as a solution to HARQ stalling issue in non-terrestrial networking. Existing processes and signaling mechanism may not enable efficient configuration and enablement/disablement of HARQ feedback which may result in degraded wireless device and wireless network performance. There is a need to enhance existing signaling and processes to enable HARQ feedback enablement/disablement and corresponding processes. Example embodiments enhance the existing signaling and processes to enable HARQ feedback enablement/disablement and corresponding processes.

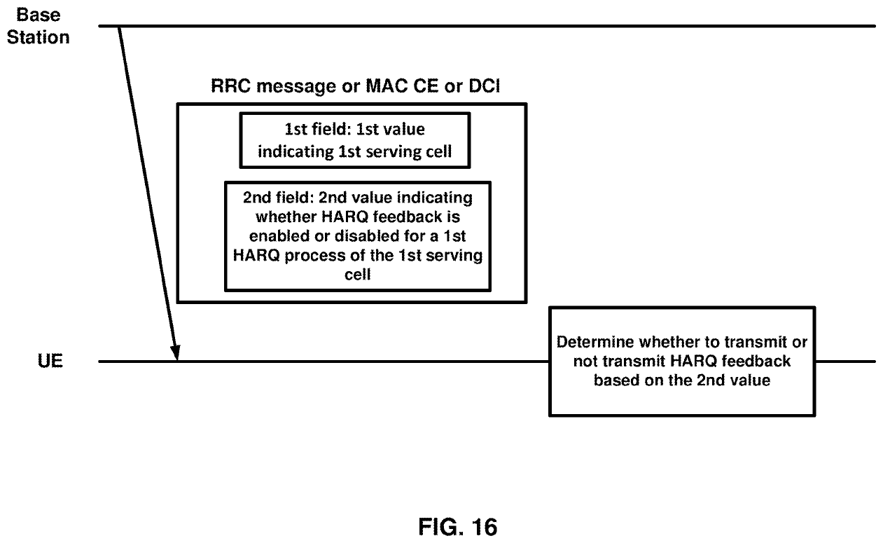

In an example embodiment as shown in FIG. 16, a UE may receive an indication/ command from a base station for disablement of HARQ feedback or enablement of the HARQ feedback. In some examples, the disablement of the HARQ feedback or enablement of the HARQ feedback may be for one or more HARQ processes. In some examples, the disablement of the HARQ feedback or the enablement of the HARQ feedback may be for one or more HARQ processes of a serving cell or for one or more HARQ processes of a plurality of serving cells of a MAC entity or for a plurality of cells in a cell group of a MAC entity. In some examples, the indication/command may be based on an RRC message and/or based on a MAC command (e.g., a MAC CE) and/or based on physical layer signaling (e.g., a DCI received via PDCCH).

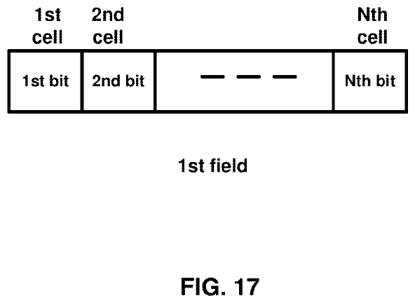

The indication/command (e.g., the RRC message, the RRC message, the MAC CE or the DCI) for enablement or disablement of the HARQ feedback, for the one or more HARQ processes (e.g., one or more HARQ processes of one or more serving cells), may comprise a first field and a second field. The first field of the command/indication (e.g., a first value of the first field) may indicate at least one serving cell. The first field (e.g., a first value of the first field) may indicate at least one serving cell that the second field (e.g., one or more HARQ processes indicated by the second field) is associated with (e.g., for HARQ feedback enablement/disablement) or at least one serving cell that the second field applies to. For example, the first value of the first field may indicate at least one identifier of the at least one serving cell. In some examples as shown in FIG. 17, the first field may comprise a plurality of bits and one or more bits of the plurality of bits may correspond to a serving cell, where a value of the one or more bits may indicate that the second field is applicable to the serving cell. In response to receiving the indication, the UE may determine whether to transmit HARQ feedback or not transmit the HARQ feedback, e.g., transmit or not transmit the HARQ feedback for one or more HARQ processes of the at least one serving cell.

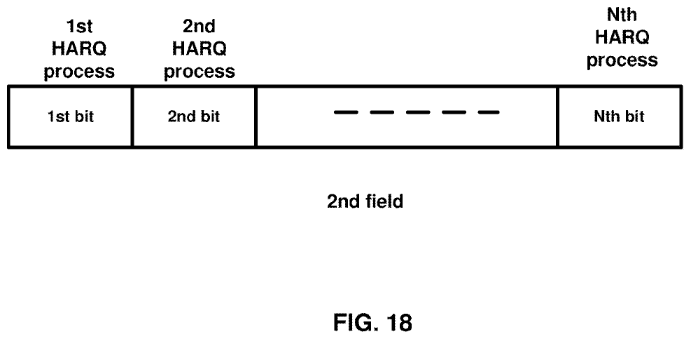

In some examples as shown in FIG. 18, the second field of the indication/command (e.g., the RRC message, the MAC CE or the DCI) may comprise a plurality of bits. Each one or more bits of the plurality of bits may correspond to a HARQ process number. Based on a value of the one or more bits of the plurality of bits (e.g., a value of one) that correspond to a first HARQ process, the HARQ feedback for the first HARQ process may be enabled and based on the value of the one or more bits of the plurality of bits (e.g., a value of zero) that correspond to a first HARQ process, the HARQ feedback for the first HARQ process may be disabled.

In some examples, the indication/command may be MAC CE. In some examples, a format of the MAC CE may be associated with indication of enablement or disablement of HARQ feedback for one or more HARQ processes (e.g., enablement or disablement of HARQ feedback for one or more HARQ processes of one or more serving cells). In some examples, an LCID associated with the MAC CE may be associated with indication of enablement or disablement of HARQ feedback for one or more HARQ processes (e.g., enablement or disablement of HARQ feedback for one or more HARQ processes of one or more serving cells).

In some examples, the indication/command may be a DCI. For example, the DCI may be a scheduling DCI comprising scheduling information for an uplink transmission (e.g., via PUSCH) or a downlink transmission (e.g., via PDSCH). For example, the DCI may be a scheduling DCI for a downlink TB and the scheduling DCI may indicate whether HARQ feedback for the downlink TB or for the HARQ process associated with the downlink TB is enabled or disabled. In some examples, the UE may receive SPS configuration parameters of a SPS configuration, and the DCI may be an activation DCI for the SPS configuration. The activation DCI may indicate whether HARQ feedbacks of the downlink TBs received based on the SPS configuration is enabled or disabled. In some examples, the activation DCI may indicate whether the HARQ feedback of the downlink TBs received based on the SPS configuration and regardless of the HARQ processes associated with the downlink TBs is enabled or disabled. In some examples, the activation DCI may indicate whether the HARQ feedback of the downlink TBs received based on the SPS configuration and for certain HARQ processes associated with the downlink TBs is enabled or disabled. In some examples, a format of the DCI may be associated with indication of enablement or disablement of HARQ feedback for one or more HARQ processes (e.g., enablement or disablement of HARQ feedback for one or more HARQ processes of one or more serving cells). In some examples, an RNTI associated with the DCI may be associated with indication of enablement or disablement of one or more HARQ feedbacks (e.g., enablement or disablement of HARQ feedback for one or more HARQ processes of one or more serving cells).

In some examples, the UE may generate a HARQ feedback codebook comprising HARQ feedbacks (e.g., comprising HARQ feedback for HARQ processes for which HARQ feedback is enabled/not disabled). The UE may transmit the HARQ feedback codebook via an uplink control channel. The size of the HARQ feedback codebook may be based on the number of HARQ processes (e.g., number of HARQ processes for one or more serving cells) for which HARQ feedback is enabled.

In some examples, in response to receiving the indication (e.g., RRC message, MAC CE and/or DCI) indicating disablement of HARQ feedback for one or more HARQ processes for one or more serving cells, the UE may flush HARQ buffers associated with the one or more HARQ processes for the one or more serving cells. The UE may flush pending HARQ processes among the one or more HARQ processes (e.g., one or more HARQ processes of the one or more cells) for which HARQ feedback is disabled.

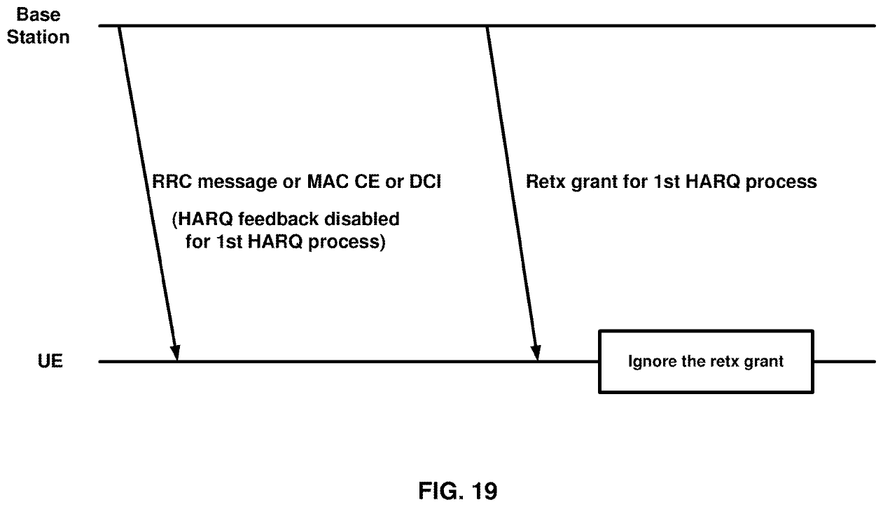

In some examples as shown in FIG. 19, after receiving the indication (e.g., RRC message, MAC CE and/or DCI) indicating disablement of HARQ feedback for one or more HARQ processes (e.g., one or more HARQ processes of the one or more serving cells), the UE may receive a retransmission grant for a HARQ process in the one or more HARQ processes. The UE may receive the retransmission grant for the HARQ process after receiving a TB associated with the HARQ process. Based on the HARQ feedback for the HARQ process being disabled, the UE may ignore the retransmission grant.

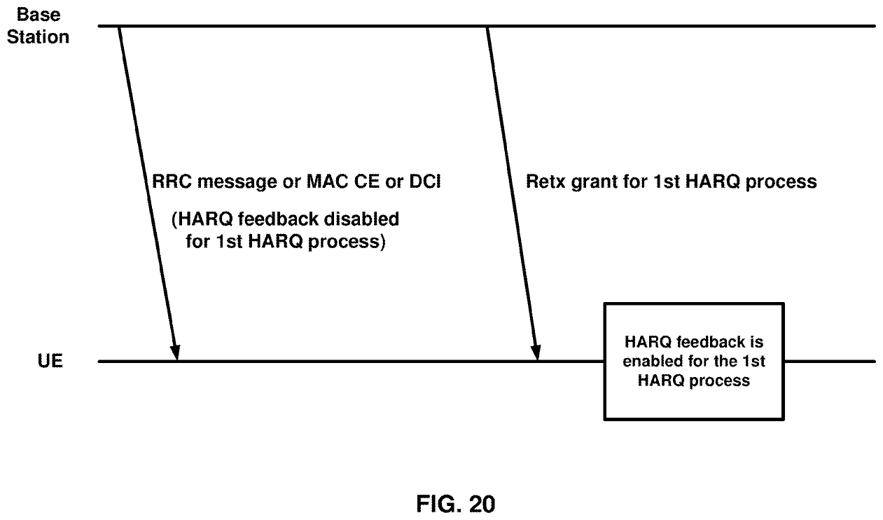

In some examples as shown in FIG. 20, after receiving the indication (e.g., RRC message, MAC CE and/or DCI) indicating disablement of HARQ feedback for one or more HARQ processes (e.g., one or more HARQ processes of the one or more serving cells), the UE may receive a retransmission grant for a HARQ process in the one or more HARQ processes. The UE may consider the retransmission grant as an indication that HARQ feedback for the HARQ process is no longer disabled. The UE may consider the HARQ feedback for the HARQ process to be enabled. The UE may transmit HARQ feedback for the downlink TB received based on/after receiving the retransmission grant.

In some examples, the HARQ feedback for a HARQ process for which HARQ feedback is disabled may be considered (e.g., by the base station) as positive acknowledgement (ACK). The base station may assume that the TB associated with the HARQ process for which the HARQ feedback is disabled is an ACK.

In some examples, the UE may determine whether HARQ feedback for a HARQ process is enabled or disabled further based on a size of a scheduled TB. For example, the determination to disable HARQ feedback for a HARQ process may be based on the size of the scheduled TB, e.g., based on whether the size of the scheduled TB is less than a threshold (e.g., a configurable, e.g., RRC configurable threshold). In some examples, the size of the scheduled TB may be based on a modulation and coding schedule (MCS) and allocated resources for the TB. The MCS and resource allocation may be determined based on the scheduling DCI (e.g., based on the MCS and resource allocation fields of the scheduling DCI) or based on an SPS activation DCI (e.g., based on the MCS and resource allocation fields of the SPS activation DCI) in case the TB is a SPS TB.

In some examples, the indication/command (e.g., the RRC message, the RRC message, the MAC CE or the DCI) for enablement or disablement of the HARQ feedback, for the one or more HARQ processes (e.g., one or more HARQ processes of one or more serving cells) may further indicate a duration that the HARQ feedback for the one or more HARQ processes is enabled or disabled. In some examples, the duration may be in number of symbols or un number of slots or in number of subframes or in number of frames. In some examples, the duration may be configurable, e.g., based on a received RRC configuration parameters.

In an example embodiment, a user equipment (UE) may receive one of a radio resource control (RRC) message, a medium access control (MAC) control element (CE) and a downlink control information (DCI). The one of the RRC message, the MAC CE and the DCI may comprise a first field and a second filed. A first value of the first filed may indicate a first serving cell. A second value of the second field may indicate whether HARQ feedback is enabled or disabled for a first HARQ process of the first serving cell. The UE may determine whether to transmit or not transmit the HARQ feedback for the first HARQ process based on the second value.

In some examples, the second field may comprise a plurality of bits. Each bit in the plurality of bits may correspond to a HARQ process. A value of a first bit in the plurality of bits may indicate whether HARQ feedback is enabled or disabled for the first HARQ process of the first serving cell.

In some examples, the first value of the first field may indicate that the second field is associated with the first serving cell.

In some examples, the first value of the first field may indicate a first identifier of the first serving cell.

In some examples, the first field may comprise a first plurality of bits. A value of a first bit in the plurality of bits may indicate the first serving cell. In some examples, the first bit may correspond to the first serving cell. In some examples, the value of the first bit may be one.

In some examples, the medium access control (MAC) control element (CE) is associated with a first logical channel identifier (LCID). The first LCID may be for indication of enabling or disabling of one or more hybrid automatic repeat request (HARQ) processes.

In some examples, the downlink control information (DCI) may be associated with a radio network temporary identifier (RNTI). In some examples, the radio network temporary identifier (RNTI) may be for indication of enabling or disabling of one or more hybrid automatic repeat request (HARQ) processes.

In some examples, the downlink control information (DCI) may be a downlink or uplink scheduling DCI. In some examples, the scheduling downlink control information (DCI) may comprise scheduling information for reception of a transport block. The scheduling DCI indicates whether the hybrid automatic repeat request (HARQ) feedback associated with the transport block is enabled or disabled.

In some examples, the UE may receive configuration parameters of a semi-persistent scheduling (SPS) configuration, wherein the downlink control information (DCI) may be an activation DCI. In some examples, the activation downlink control information (DCI) may indicate whether hybrid automatic repeat request (HARQ) feedback is enabled or disabled for transport blocks associated with the semi-persistent scheduling (SPS) configuration. In some examples, the transport blocks associated with the semi-persistent scheduling (SPS) configuration may be associated with different hybrid automatic repeat request (HARQ) processes. The HARQ feedback may be enabled or disabled for the transport blocks regardless of the HARQ processes associated with the transport blocks.

In some examples, the UE may generate a hybrid automatic repeat request (HARQ) feedback codebook for transmission via an uplink control channel. In some examples, the hybrid automatic repeat request (HARQ) feedback codebook may comprise HARQ feedback for one or more HARQ processes for which HARQ feedback is enabled.

In some examples, the UE may flush a hybrid automatic repeat request (HARQ) buffer associated with a HARQ process for which the HARQ feedback is disabled in response to receiving an indication to disable the HARQ feedback for the HARQ process.

In some examples, the UE may receive a retransmission grant for a hybrid automatic repeat request (HARQ) process for which the HARQ feedback is disabled. The UE may ignore the retransmission grant.

In some examples, the UE may receive a retransmission grant for a hybrid automatic repeat request (HARQ) process for which the HARQ feedback is disabled. The UE may consider that HARQ feedback for the HARQ process is enabled in response to receive the retransmission grant. In some examples, the UE may transmit a hybrid automatic repeat request (HARQ) feedback associated with a transport block received based on the retransmission grant.

In some examples, the hybrid automatic repeat request (HARQ) feedback associated with the HARQ process for which HARQ feedback is disabled may be considered as positive acknowledgement.

In some examples, a hybrid automatic repeat request (HARQ) feedback for a HAQR process may be disabled based on a size of scheduled transport block associated with the HARQ process. In some examples, the UE may receive a scheduling downlink control information (DCI) or a semi-persistent scheduling (SPS) activation DCI, wherein the scheduling DCI or the SPS activation DCI may indicate the size of the scheduled transport block. In some examples, the size of the scheduled transport block may be based on a modulation and coding scheme and resources allocated for reception of the transport. In some examples, the scheduling downlink control information (DCI) or the semi-persistent scheduling (SPS) activation DCI may indicate the modulation and coding scheme and the resources.

In some examples, the indication may further indicate the duration that a hybrid automatic repeat request (HARQ) feedback is disabled. In some examples, the duration may be in number of slots. In some examples, the duration may be in number of subframes. In some examples, the duration may be in number of frames.

In some examples, a format associated with the medium access control (MAC) control element (CE) may indicate that the MAC is for enabling or disabling hybrid automatic repeat request (HARQ) feedback for one or more HARQ processes.

In some examples, a format associated with the downlink control information (DCI) may indicate that the DCI is for enabling or disabling hybrid automatic repeat request (HARQ) feedback for one or more HARQ processes.

The exemplary blocks and modules described in this disclosure with respect to the various example embodiments may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Examples of the general-purpose processor include but are not limited to a microprocessor, any conventional processor, a controller, a microcontroller, or a state machine. In some examples, a processor may be implemented using a combination of devices (e.g., a combination of a DSP and a microprocessor, multiple microprocessors, one or more microprocessors in conjunction with a DSP core, or any other such configuration).

The functions described in this disclosure may be implemented in hardware, software executed by a processor, firmware, or any combination thereof. Instructions or code may be stored or transmitted on a computer-readable medium for implementation of the functions. Other examples for implementation of the functions disclosed herein are also within the scope of this disclosure. Implementation of the functions may be via physically co-located or distributed elements (e.g., at various positions), including being distributed such that portions of functions are implemented at different physical locations.

Computer-readable media includes but is not limited to non-transitory computer storage media. A non-transitory storage medium may be accessed by a general purpose or special purpose computer. Examples of non-transitory storage media include, but are not limited to, random access memory (RAM), read-only memory (ROM), electrically erasable programmable ROM (EEPROM), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable media.

As used in this disclosure, use of the term “or” in a list of items indicates an inclusive list. The list of items may be prefaced by a phrase such as “at least one of” or “one or more of”. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

1. A method of disabling hybrid automatic repeat request (HARQ) feedback in a non-terrestrial network, comprising the steps of:
receiving, by a user equipment (UE), one of a radio resource control (RRC) message, a medium access control (MAC) control element (CE) and a downlink control information (DCI), wherein:
the RRC message, the MAC CE and the DCI comprise a first field and a second field;
a first value of the first field indicates a first serving cell; and
a second value of the second field indicates whether HARQ feedback is enabled or disabled for a first HARQ process of the first serving cell; and
determining to transmit or not to transmit the HARQ feedback for the first HARQ process based on the second value.

2. The method of claim 1, wherein:
the second field comprises a second field plurality of bits;
each bit in the second field plurality of bits corresponds to a hybrid automatic repeat request (HARQ) process; and
a value of a first bit in the second filed plurality of bits indicates whether HARQ feedback is enabled or disabled for the first HARQ process of the first serving cell.

3. The method of claim 1, wherein the first value of the first field indicates that the second field is associated with the first serving cell.

4. The method of claim 1, wherein the first value of the first field indicates a first identifier of the first serving cell.

5. The method of claim 1, wherein:
the first field comprises a first field plurality of bits; and
a value of a first bit in the first field plurality of bits indicates the first serving cell.

6. The method of claim 5, wherein the first bit corresponds to the first serving cell.

7. The method of claim 5, wherein the value of the first bit is one.

8. The method of claim 1, wherein:
the medium access control (MAC) control element (CE) is associated with a first logical channel identifier (LCID); and
the first LCID is for indication of enabling or disabling one or more hybrid automatic repeat request (HARQ) processes.

9. The method of claim 1, wherein the downlink control information (DCI) is associated with a radio network temporary identifier (RNTI).

10. The method of claim 9, wherein the radio network temporary identifier (RNTI) is for indication of enabling or disabling one or more hybrid automatic repeat request (HARQ) processes.

11. The method of claim 1, wherein the downlink control information (DCI) is a downlink or uplink scheduling DCI.

12. The method of claim 11, wherein:
the scheduling downlink control information (DCI) comprises scheduling information for reception of a transport block; and
the scheduling DCI indicates whether the hybrid automatic repeat request (HARQ) feedback associated with the transport block is enabled or disabled.

13. The method of claim 1, further comprising receiving configuration parameters of a semi-persistent scheduling (SPS) configuration, wherein the downlink control information (DCI) is an activation DCI.

14. The method of claim 12, wherein the activation downlink control information (DCI) indicates whether hybrid automatic repeat request (HARQ) feedback is enabled or disabled for transport blocks associated with the semi-persistent scheduling (SPS) configuration.

15. The method of claim 14, wherein:
the transport blocks associated with the semi-persistent scheduling (SPS) configuration are associated with different hybrid automatic repeat request (HARQ) processes; and
the HARQ feedback is enabled or disabled for the transport blocks regardless of the HARQ processes associated with the transport blocks.

16. The method of claim 1, further comprising generating a hybrid automatic repeat request (HARQ) feedback codebook for transmission via an uplink control channel.

17. The method of claim 16, wherein the hybrid automatic repeat request (HARQ) feedback codebook comprises HARQ feedbacks for one or more HARQ processes for which HARQ feedback is enabled.

18. The method of claim 16, wherein a size of the hybrid automatic repeat request (HARQ) feedback codebook is based on a number of HARQ processes for which HARQ feedback is enabled.

19. The method of claim 1, further comprising flushing a hybrid automatic repeat request (HARQ) buffer associated with a HARQ process for which the HARQ feedback is disabled in response to receiving an indication to disable the HARQ feedback for the HARQ process.

20. The method of claim 1, further comprising:
receiving a retransmission grant for a hybrid automatic repeat request (HARQ) process for which the HARQ feedback is disabled; and
ignoring the retransmission grant.
